(19) United States
(12) Patent Application Publication
(10) Pub. No.: US 2023/0306368 A1
(43) Pub. Date: Sep. 28, 2023

(54) SYSTEMS AND METHODS FOR VENDOR OFFBOARDING

(71) Applicant: Venminder, Inc., Elizabethtown, KY (US)

(72) Inventor: Dana A. Bowers, Elizabethtown, KY (US)

(21) Appl. No.: 18/187,573

(22) Filed: Mar. 21, 2023

Related U.S. Application Data
(60) Provisional application No. 63/322,616, filed on Mar. 22, 2022.

(51) Int. Cl. G06Q 10/10

(52) U.S. Cl. CPC G06Q 10/103

(57) ABSTRACT

Methods and systems are presented herein for vetting, approving and/or declining vendors and/or their products or services for financial institutions.

### CROSS-REFERENCE TO RELATED APPLICATIONS

This application claims priority to and the benefit of U.S. Provisional Patent Application Ser. No. 63/322,616, filed Mar. 22, 2022, entitled “SYSTEMS AND METHODS FOR VENDOR OFFBOARDING,” the disclosure of which is incorporated herein by reference in its entirety.

### FIELD OF THE INVENTION

This invention relates generally to systems and methods for managing client/vendor relationships. More particularly, in certain embodiments, the invention relates to systems and methods for providing vendor and agreement management.

### BACKGROUND

Financial institutions such as banks and credit unions are increasingly relying on third-party vendors to perform various important functions. While this improves efficiency and reduces cost for the financial institution, there are various risks posed by such outsourcing. A financial institution (“FI”) must establish a vendor oversight program to mitigate such risks, comply with various regulations, and pass examination by auditors. Generally, maintaining oversight of different vendors and vendor products requires a coordination of large amounts of oversight requirements, tasks, documents, results, due dates, and individuals.

The vendor management process has historically been disjointed, messy, and time-consuming. A single financial institution may have numerous vendors to manage, and there may be many individuals within a given financial institution who deal with a given vendor and must coordinate collection of documents and data regarding the corresponding vendor products. Furthermore, the terms of various contracts between a financial institution and its vendors must be carefully monitored.

Moreover, financial institutions may wish to maintain different types of information about the vendors and vendor products with which they are associated. Traditional vendor management systems allow financial institutions to maintain information according to a predetermined set of fields. Handling multiple vendor contracts, products, workflows, payment requests, oversight tasks, and other tasks individually gets cumbersome, even when working with only a single vendor. Managing multiple vendors can make an already challenging task orders or magnitude more difficult.

### SUMMARY

Methods and systems are presented herein for adding, to a vendor management system, information relating to one or more (new) vendors providing services and/or other products to the financial institution. Methods and systems are presented herein provide a consolidated, efficient system for managing contracts between a financial institution and its vendors. Specifically, methods and systems for the onboarding and offboarding of vendors (i.e., vendor authorizations, vendor data, vendor software and products, vendor contracts and agreements, and other aspects of vendor collaborations, as described herein).

In one aspect, the present disclosure is directed to method for managing one or more vendors and/or products. In some embodiments, the method includes a step of causing to display, by a processor of an enterprise system, one or more graphical user interfaces (GUIs) associated with one or more vendor request modules. In some embodiments, the method includes a step of receiving, by the processor of the enterprise system, a first input (e.g., received via a graphical user interface widget) from a first client user (e.g., said first client user having been authorized to access the enterprise system, e.g., said first client user being one member of a network of subscribed clients), the first input including instructions to access a vendor request from. In some embodiments, the method includes a step of receiving, by the processor of the enterprise system, (e.g., received via a graphical user interface widget) data field information related to said vendor and/or product. In some embodiments, the method includes a step of updating, in a memory of the enterprise system, vendor and/or product information stored in association with the first client, based on the subsequent input. In some embodiments, the vendor request module is configured to track one or more vendor and/or product metrics associated with the vendor.

In some embodiments, the subsequent input is received via a master form GUI or a custom form GUI. In some embodiments, the subsequent input includes at least custom data field information related to vendor name, product name, product type, and criticality. In some embodiments, if the subsequent input is associated with a current or incumbent vendor, by the system, a master form GUI or a custom form GUI may be populated automatically with existing data retrieved from a system database. In some embodiments, the subsequent input is or includes data field information requesting approval of a vendor, wherein, if a vendor request contains multiple vendor products and one is approved, the other vendor products associated will be automatically declined by the system.

In some embodiments, the vendor management system includes vendor offboarding as an individual sellable line item available within the Sales & Contracting module. The feature must be included in the client's purchase plan in order for the menu panel option in the client experience to display as an upsell link. In some embodiments, vendor offboarding includes a vendor offboarding module which allows the client to autonomously perform several offboarding tasks simply by approving vendor offboarding request.

In another aspect, the present disclosure is directed to a method for managing one or more vendors and/or products, the method including the steps of: causing to display, by a processor of an enterprise system, one or more graphical user interfaces (GUIs) associated with one or more vendor request modules, the one or more vendor request modules comprising a vendor offboarding module; receiving, by the processor of the enterprise system, a first input from a first client user, the first input comprising instructions to access a vendor request form, the first client user comprising a vendor offboarding requestor, the vendor request form comprising a vendor offboarding request form; receiving, by the processor of the enterprise system, data field information related to said vendor and/or product; and updating, in a memory of the enterprise system, vendor and/or product information stored in association with the first client, based on the subsequent input.

In some embodiments, the method further comprises sending the vendor offboarding request form to a vendor management officer (VMO) for approval, wherein the vendor offboarding request form comprises a vendor offboarding request.

In some embodiments, upon approving, by the vendor management officer (VMO), the vendor offboarding request, the processor causes a status of at least one contract in a contract management system to change from active to inactive.

In some embodiments, upon approving, by the vendor management officer (VMO), the vendor offboarding request, the processor causes a status of at least one service level agreement to change from active to inactive.

In some embodiments, upon approving, by the vendor management officer (VMO), the vendor offboarding request, the processor causes at least one vendor product to be deactivated.

In some embodiments, approving the vendor offboarding request comprises clicking an offboard and deactivate button.

In some embodiments, the method further includes: after approving the vendor offboarding request, sending an executable file to a network scheduler for deployment to all managed device that are running the vendor product.

In some embodiments, the executable file uninstalls the vendor product from all managed devices.

In some embodiments, the executable file uninstalls the vendor product from all networks and servers operating within at least one of a local area network (LAN) and a wide area network (WAN) in which the vendor product is operating.

In some embodiments, the executable file comprises an address indicating where the vendor product is installed on each of the managed devices.

In some embodiments, the address is imported from a configuration file that is created during an onboarding process during which the vendor product was installed on each of the managed devices.

In some embodiments, the executable file uses the address to uninstall the product from the managed devices.

In some embodiments, the subsequent input is or comprises data field information requesting approval of a vendor offboarding request.

In another aspect, the present disclosure is directed to a method for offboarding one or more vendors, the method comprising the steps of: executing an offboarding routine comprising checking that a series of flags are satisfied; and automatically purging the vendor from the system once every flag of the series of flags are satisfied, wherein the series of flags comprise one or more of an approval type flag, a request approval flag, a offboarding period flag, and a request withdrawal flag.

In some embodiments, the method further comprises automatically disabling system functionality associated with the one or more vendors upon at least one of the following conditions occurring: a vendor offboarding request is made; and a vendor offboarding request is approved.

In another aspect, the present disclosure is directed to a system configured to carry out any of the methods described herein.

### BRIEF DESCRIPTION OF THE FIGURES

The foregoing and other objects, aspects, features, and advantages of the present disclosure will become more apparent and better understood by referring to the following description taken in conjunction with the accompanying drawings, in which:

FIG. 1 is a block diagram of an example system for managing contracts between a financial institution and its vendors.

FIG. 2 is a block diagram of the example system for managing contracts between the financial institution and its vendors in accordance with an embodiment of the invention.

FIG. 3 is an example main dashboard in accordance with an embodiment of the invention.

FIG. 4 is an example vendor dashboard in accordance with an embodiment of the invention.

FIG. 5 is an example document storage page in accordance with an embodiment of the invention.

FIG. 6 is an example workflow of the system in guiding an end-user in preparing a vendor oversight report associated with one or more selected vendor products in accordance with an embodiment of the invention.

FIG. 7 is an example vendor exam preparation workspace in accordance with an embodiment of the invention.

FIG. 8 is an example workspace for collecting documents by matching collected end-user's document to a list of suggested documents in accordance with an embodiment of the invention.

FIG. 9 is an example workspace for collecting documents by prompting the end user for selection of actions for unassigned documents that have been provided by the end user in accordance with an embodiment of the invention.

FIG. 10 is an example workspace for collecting documents by prompting the end user for selection of actions for unassigned suggested documents in accordance with an embodiment of the invention.

FIG. 11 is an example workspace for preparing a collected document for the examination report in accordance with an embodiment of the invention.

FIG. 12 is an example workspace for uploading document to be attached and included in the examination in accordance with an embodiment of the invention.

FIG. 13 is an example workspace to previewing contents to be included in the examination report.

FIG. 14 is an example workspace to review vendor products in accordance with an embodiment of the invention.

FIG. 15 is an example display for viewing product review in accordance with an embodiment of the invention.

FIG. 16 is an example alert and information display in accordance with an embodiment of the invention.

FIG. 17 is an example standard vendor onboarding form.

FIG. 18 is an example vendor onboarding settings: approval settings window in accordance with an embodiment of the invention.

FIG. 19 is an example vendor onboarding form workspace in accordance with an embodiment of the invention.

FIG. 20 is an example vendor request form (minimal fields) workspace in accordance with an embodiment of the invention.

FIG. 21 is an example risk assessment section of a request form workspace in accordance with an embodiment of the invention.

FIG. 22 is an example import profile items window in accordance with an embodiment of the invention.

FIG. 23 is an example profile item selection workspace in accordance with an embodiment of the invention.

FIG. 24 is an example custom onboarding form field workspace in accordance with an embodiment of the invention.

FIG. 25 is an example request a vendor preliminary form workspace in accordance with an embodiment of the invention.

FIG. 26 is an example request a vendor workspace in accordance with an embodiment of the invention.

FIG. 27 is an example vendor request flow diagram in accordance with an embodiment of the invention.

FIG. 28 is an example vendor request workspace in accordance with an embodiment of the invention.

FIG. 29 is an example view vendor request form workspace in accordance with an embodiment of the invention.

FIG. 30 is an example vendor request form with comparison view workspace in accordance with an embodiment of the invention.

FIG. 31 is an example requirements status bar on a vendor request form workspace in accordance with an embodiment of the invention.

FIG. 32 is an example requirements status overview workspace in accordance with an embodiment of the invention.

FIG. 33 is an example diagram illustrating mapping from vendor onboarding to other areas of the system application in accordance with an embodiment of the invention.

FIG. 34 is a block diagram of an example network environment for use in the methods and systems for analysis of spectrometry data, according to an illustrative embodiment.

FIG. 35 is a block diagram of an example computing device and an example mobile computing device, for use in illustrative embodiments of the invention.

FIG. 36 is illustrates a vendor offboarding system, or process flow, according to aspects of the present embodiments.

FIG. 37 is an example standard vendor offboarding form, according to aspects of the present embodiments.

FIG. 38 illustrates a view displayed by the vendor offboarding module, according to aspects of the present embodiments.

FIG. 39 illustrates a view displayed by the vendor offboarding module, according to aspects of the present embodiments.

FIG. 40 illustrates a vendor offboarding form, according to aspects of the present embodiments.

FIG. 41 illustrates a view of the possible answers to the timeframe question of the vendor offboarding form, according to aspects of the present embodiments.

FIG. 42 illustrates a view of the vendor offboarding dashboard, according to aspects of the present embodiments.

FIG. 43 illustrates an offboard vendor product dialog box, according to aspects of the present embodiments.

FIG. 44 illustrates a vendor request display, according to aspects of the present embodiments.

FIG. 45 illustrates an administrative panel including offboarding workflow templates, according to aspects of the present embodiments.

FIG. 46 illustrates a new offboarding workflow form, according to aspects of the present embodiments.

FIG. 47 illustrates a preloaded offboarding workflow, according to aspects of the present embodiments.

FIG. 48 illustrates a custom message, according to aspects of the present embodiments.

FIG. 49 illustrates a VMO Information section, according to aspects of the present embodiments.

FIG. 50 illustrates a final approve/decline action bar, according to aspects of the present embodiments.

The features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements.

### Definitions

Client: Organization that uses Venminder (or other equivalent) software.
Purchase Plan: Outlines the client's access to modules within the Venminder software.
Administrator: Client users that have access to the admin panel and system settings that ‘controls’ how the client's Venminder account functions.
Requestor: User who submitted the vendor offboarding request.
VMO: Vendor Management Office/Officer.
Workflows: Module provided by Venminder (or other software provider) that allows users to define and automate required activities or tasks using rule-based logic.
Vendor Offboarding: Module provided by Venminder (or other software provider).

### DETAILED DESCRIPTION

Methods and systems are presented herein for assessing risk associated with a vendor providing services and/or other products to a financial institution, for preparation of associated risk assessment reports or vendor oversight reports, and for maintenance of a plurality of risk assessment reports associated with a plurality of vendors. In some embodiments, the disclosed methods and systems may be used to both onboard and offboard vendor products (and associated data, workflows, contracts, service level agreements, and/or other tasks) from a client enterprise system.

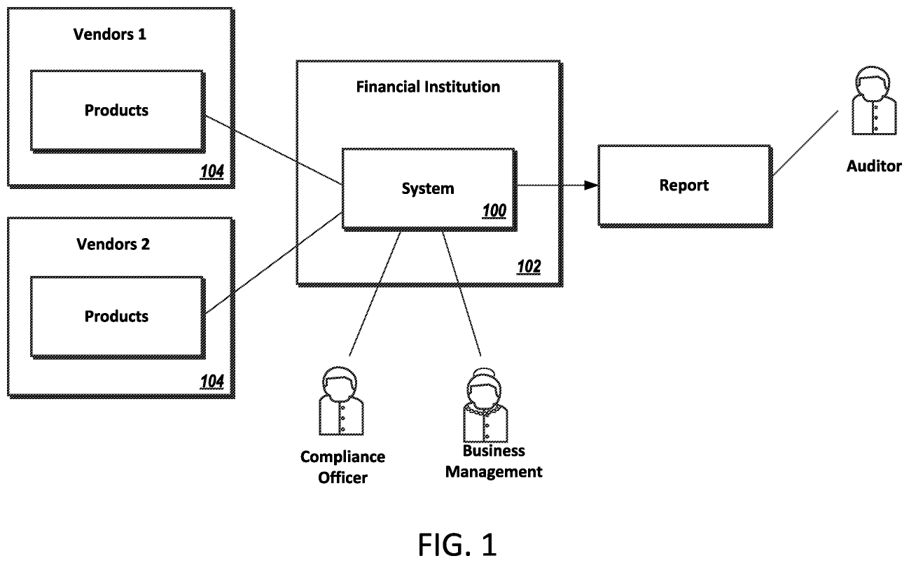

FIG. 1 is a block diagram of an example system 100 to assist financial institutions 102 to manage vendors 104 in accordance with an embodiment of the invention. In some implementations, the system 100 provides guided workflow to i) manage contracts with a given vendor 104, to provide a guided workflow to assist the financial institution 102 to prepare for an compliance or contract audit examination, ii) provide a rating system of the vendors 104 and their products and services, iii) provide a risk-assessment rating-system for the vendors 104, and iv) provide mechanisms for collaboration, the tracking of communication, and document storage.

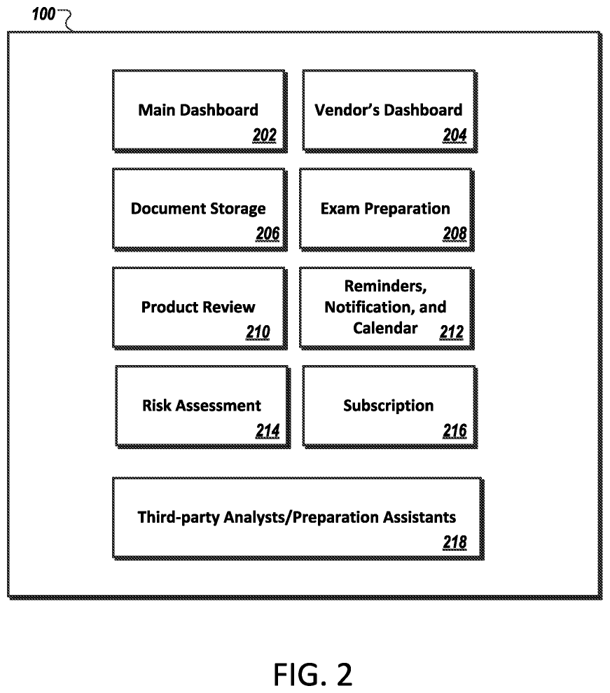

FIG. 2 is a block diagram of the example system 100 for managing contracts between the financial institution and its vendors in accordance with an embodiment of the invention. The system 100 may include a main dashboard 202 for managing actions associated with a given vendor 104 and to track such actions. The system 100 may include a vendor dashboard 204 to view and manage products and vendors associated with a given financial institution. The system 100 may include a document storage page 206 to view and manage documents associated with the vendors and their products. In some implementations, the document storage page 206 may be accessible via the main dashboard 202 and the vendor dashboard 204.

The system 100 may include a reminder, notification, and/or calendar function 212. The function 212 may manage and store a list of dates associated with expiration of a given document or contract as well as a list of personal reminders provided by the end-users. The function 212 may display such reminders in a calendar display. The function 212 may send notifications to the end-user based on pre-defined rules associated with an examination. The rules may be related to the expiration date of a given product or agreement, a scheduled examination, a risk-assessment evaluation, and etc.

The function 212 may include an alert and/or information feed (e.g., new documents uploaded, new reviews added, status update on a given examination or preparation process, etc.). The alert may include a progress bar to indicate a given end-user progress with a given task.

The alert may include an experience bar to indicate a given end-user usage level associated with the various functions of the system 100.

The system 100 may include a risk-assessment module 214 to guide an end-user in assigning a risk rating for a given vendor and/or product. The risk-rating may be utilized as part of the reporting of the compliance and/or contract audit examination. In some implementations, the risk rating may be used to determine the types of information and the types of documents to include in the examination report.

The system 100 may include a subscription module 216. The subscription module 216 may manage and maintain usage by the end-user of the various system components (e.g., 202, 204, 206, 208, 210, 212, and 214) for a given financial institution. The system 100 may monitor the end-user's action, such as the usage of complimentary tools and document storage, purchases of additional tools and document storage, purchases of enterprise features, among others.

In some example embodiments, the system may include one or more modules for executing, providing and/or causing to display one or more graphical user interfaces (GUIs) and/or widgets. The GUIs and/or widgets may include a vendor profile widgets for, among other things, managing vendor profiles; oversight grid widgets for, among other things, providing grid-based oversight of oversight requirements; task widgets for, among other things, managing tasks associated with oversight requirements; oversight management widgets for, among other things, managing tasks and oversight requirements associated with vendors and/or vendor products; document widgets for, among other things, managing documents associated with tasks; administrator widgets for, among other things, managing users; dashboard widgets for, among other things, managing outstanding tasks and vendor products associated with users; and reports widgets for, among other things, generating status, task and/or vendor reports.

In some example embodiments, data associated with vendors (e.g., vendor management information), which is used by the GUIs and/or widgets, may be stored in a memory of the system 100 or of a client computing device associated with the system 100. In some example embodiments, the system 100 is an enterprise system with which one or more enterprise client computing devices are connected. The GUIs and/or widgets are described in further detail below.

### Main Dashboard

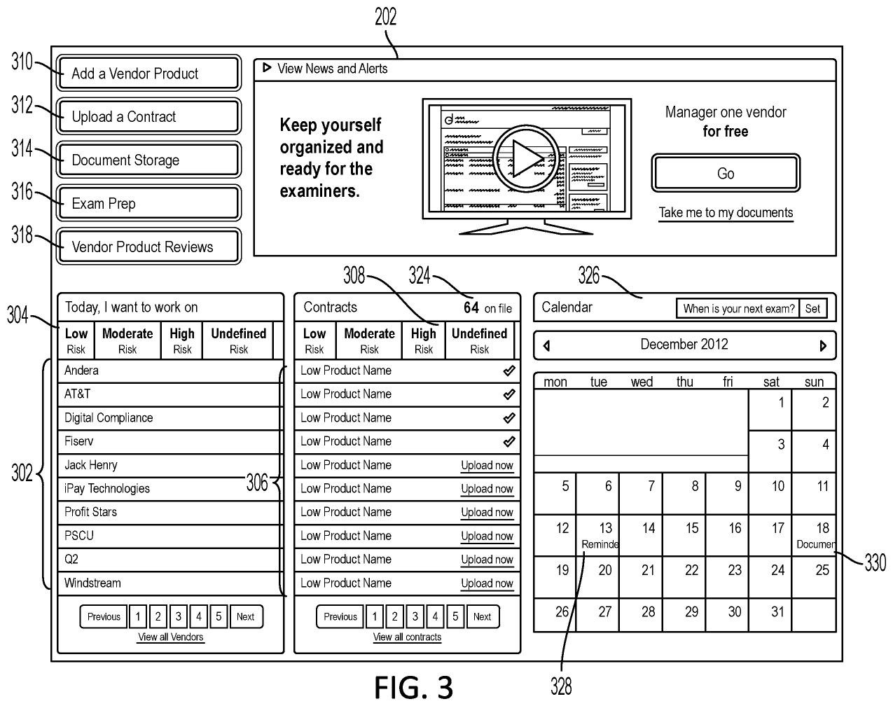

FIG. 3 is an example main dashboard 202 in accordance with an embodiment of the invention. The main dashboard 202 may be used to initiate the various functions, as described in relation to FIG. 2. The main dashboard 202 may display a vendor list 302, which may be organized and filtered by a vendor's risk level 304 (e.g., low, medium, high, or undefined/unknown). The main dashboard 202 may display a contract list 306, which may also be organized and filtered by risk levels 308. The main dashboard 202 may display a number of contracts on file (324), such as those stored in the document storage 206.

The main dashboard 202 may include a calendar 326 that displays reminder dates 328 and expiration dates 330 of contracts, of risk assessment of vendors and/or products, as well as of upcoming examinations. In some implementations, the calendar 326 may include dates in which notifications will be sent by the system. In some implementations, the calendar 326 may only display the expiration dates for documents that are uploaded by the end-user.

In some implementations, upon selecting a date in the calendar 326, the system 100 may prompt the end-user to create a reminder (e.g., for email communication, SMS-message, and other methods of notification accessible to and specified by the end-user). The system 100 may display a content of a reminder when the end-user hovers the cursor thereover. The calendar may be a part of the reminders, notification, and calendar function 212. The alerts and reminders of the calendar 326 may be employed to notify the end-user of upcoming critical dates (e.g., renewal date). The notification may be generated based on the date of the given activity having met an alert condition (e.g., exceeding a date threshold in relation to the critical date).

The main dashboard 202 may include a function to add a vendor product (310), a function to upload a contract associated with a given product (312), a function to manage stored documents (314), a function to prepare for an examination (316), and a function to review and manage reviews for a given vendor products (318).

The main dashboard 202 may be displayed to the users upon login to the system 100.

In some implementations, when adding a new vendor product (310), the system 100 may present the end user with a list of products. The list may include all products associated to the financial institution, including those that are not currently being managed by any of the end-user of that institution as well as those that do not have a contract loaded. The list of products may be maintained within a database that is managed by the system 100.

When adding a new vendor product, the system 100 may present the end-user with a list of questions associated with the product. The questions may include a request for the vendor name, the product name, the product type, and a risk level. The risk level may be defined as low, medium, high, and undefined (as corresponding to the risk level 304). Alternatively, the risk level may be an input from the risk-assessment module 214.

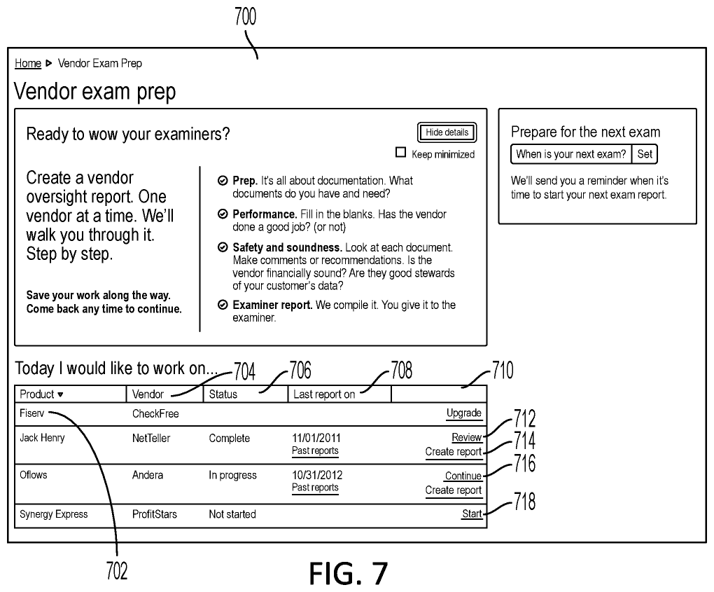

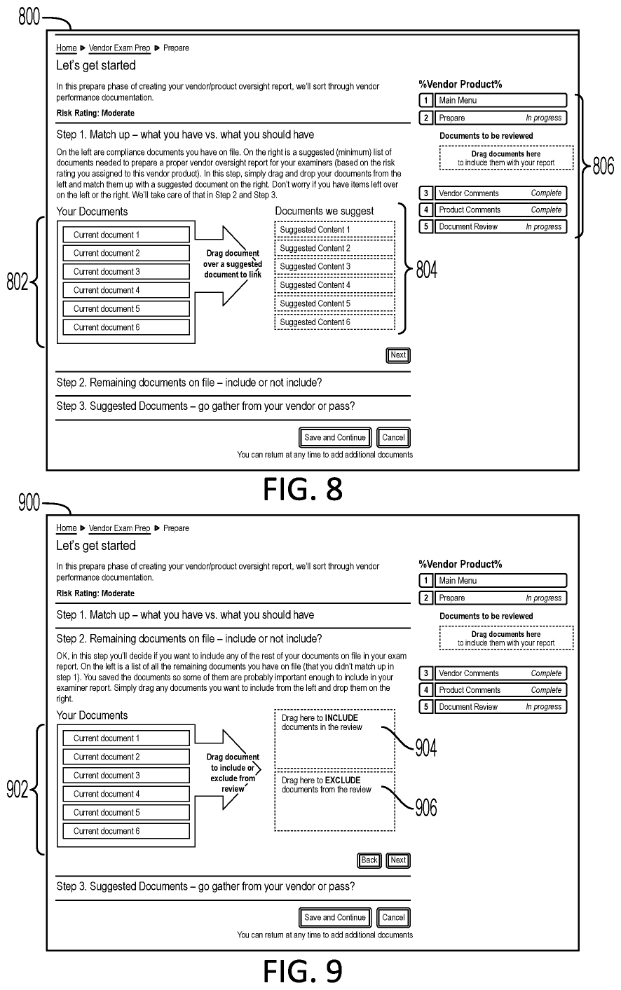

In some implementations, the risk-levels 304, 308 may be used to determine a suggested document 320 (see—see FIG. 8) in the examination-preparation area 322 (not shown—see FIGS. 7-13). Once the vendor product is added, the system 100 may present the end-user with a notification that the product has been added. In the notification, the system 100 may include a link or a selection that allows the end-user to upload a contract associated with the added vendor product. The system may also provide a link or selection to add a collaborator or to add contact information of the vendor.

In some implementations, the system 100 allows more than one person to interact with a vendor. The collaboration function allows the system 100 to receive information from the end-user about co-workers or other people in the end-user's organization that may perform actions or provide reviews for a given vendor and/or vendor product. In some implementations, the collaborator may perform any of the end-user's function (e.g., upload contract, add notes and reminders, save email conversation, and document events), though may not change or undo any of the actions performed by the end-users. Each of the vendor products may be assigned a different point of contact (i.e., a product manager). The system 100 may provide a search function for the end-user to determine if an added collaborator is already registered with the system 100.

In some implementations, when uploading a contract associated with a given product (312), the system 100 may prompt the end-user for a file. Multiple files may be selected and uploaded in a given instance. The system 100 may send a notification to the end-user that the contract has been uploaded and that a notification will be sent when it is ready for review. In some implementations, the contract may be transmitted to a third-party that analyzes and/or prepare the contract for review by the end-user. The system 100 may use aliases table. Examples of tools utilized by the third-party to analyze and prepare the contract are described in Appendices E and F of the U.S. Provisional Patent Application No. 61/805,066, which is incorporated by reference herein in its entirety.

### Vendor Dashboard

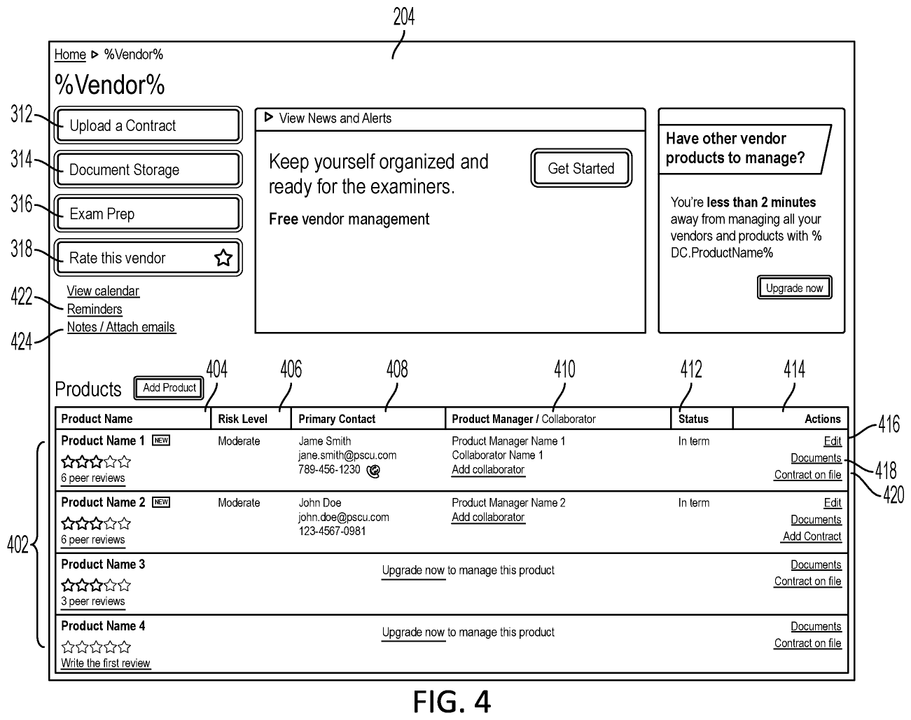

FIG. 4 is an example vendor dashboard 204 in accordance with an embodiment of the invention. In some implementations, the vendor dashboard 204 may be accessed by the end-user when the user selects a vendor from the list of vendors 302 in the main dashboard 202.

In some implementations, the vendor dashboard 204 may include the function to upload a contract associated with a given product (312), the function to manage stored documents (314), the function to prepare for an examination (316), and the function to view and manage reviews for a given vendor products (318).

In some implementations, the vendor dashboard 204 may include a list of vendor products (402) that are associated to the financial institution. The list 402 may include, for example, but not limited to, products that are currently being managed as well as products that are yet to be assigned to a given product manager. For each of the products in the list 402, the system 100 may display a product name 404, a risk level that has been assigned to the product 406, a vendor contact information 408, an assigned product manager (of the financial institution) 410, a status indicator of the product 412, and actionable tasks 414 associated with a given product. The actionable tasks 414 may allow an end-user to edit a given product information (416), to view or manage the document associated with the given product (418), and to add a contract or edit the contract on file associated with the given product (420).

Upon a selection of a product in the list 402, the system 100 may prompt the end-user whether to assign a product-manager for the product. The prompt may further include details and information about the product, including, for example, the vendor name, the product name, the product type, and the source of the product. Upon the end user providing the information, the system 100 may provide options to allow the end-user to upload a contract, to add a collaborator, or to add contact information.

Upon a selection to edit a product (416), the system 100 may display the information about an added product (e.g., the vendor name, the product name, the product type, and a risk level), as described in FIG. 3. The system 100 may also display the vendor's contact-information and/or a list of assigned collaborators.

The system 100 may provide a selection to allow the end-user to remove collaborators from specific products.

Upon a selection to edit a contract (420) associated with a product, the system 100 may display information relating to the contract, including the status of the contract (e.g., “in-term”, “renewal negotiation”, “auto-renew”, “cancelled”, “replaced”, etc.), the contract files (which may include one or more files), the end-user that uploaded the contract, the upload date, the contract date, the contract expiration date, a list of products associated with the contract, and certain key clauses (e.g., whether the contract includes an auto-renewal clause, information relating to the number of days required for a non-renewal notice, and an auto-renewal period). The system 100 may also display information relating to the contract terms (e.g., sale price per unit, etc.), comments associated with the term (e.g., whether the contract is a service-level agreement (SLA)), the vendor signatory, the institution signatory, among others. The system 100 may provide a prompt to the end-user to edit or replace the contract.

In addition, the system 100 may take actions and set reminders. Example actions of the system 100 are summarized in Table 1.

TABLE 1

| Status | Description | Action | Email Communication |
|---|---|---|---|
| In Term | Contract has not reached | No action taken | Initiate communication |
| | expiration date | | six months from |
| | | | expiration date |
| Renewal | Financial Institution is | No action taken | Sent on the expiration |
| negotiation | working on a new contract | | date |
| | terms | | |
| Auto- | Automatically renew terms | Change the contract | Sent on the expiration |
| Renew | of the contract based on the | expiration date based | date |
| | info entered when the | on the terms loaded in | |
| | contract was loaded | the upload contract | |
| | | form | |
| Cancelled | Contract is no longer valid | All products/ | Sent on the expiration |
| | | documents associated | date |
| | | with the contract will | |
| | | also be in cancelled | |
| | | status and archived | |
| Replace | Financial Institution | Move old contract to | |
| | replacing the existing | archives/new | |
| | contract with a new one | contract starts the | |
| | | upload contract | |
| | | process over | |

In addition, upon a selection to edit a contract, the system 100 may provide guidance to the end-user depending on the various selected options. For example, if the end-user specifies “renewal negotiation” (which indicates that the end-user is currently negotiating the contract with the vendor), the system 100 may provide a message that states: “By setting a contract to renewal-negotiation, you will no longer receive notices regarding contract expiration and/or auto-renewal. Change your status when you are ready. You can either upload your new contract or cancel your existing contract.” The system 100 may also take action, such as to stop the sending of the contract expiration emails.

In another example, if the end-user specifies “auto-renew” (which indicates that the contract would auto-renew with the terms as originally provided), the system 100 may prompt the end-user for a new expiration date for the contract and a date for new reminders.

In yet another example, if the end-user specifies “cancelled” (which indicates that the contract has been canceled), the system 100 may notify the end-user that the system 100 will cancel all of the selected products, archive all of the uploaded documents, and archive all of the uploaded contracts. The system 100 may also prompt the end-user for new vendor information. The system 100 may also prompt the end-user to upload a new contract or document.

In yet another example, if the end-user specifies “replace contract” (which indicates that the end-user wishes to replace an existing contract with a new contract), the system 100 may prompt the end-user for new documents associated with the new contact. The system 100 may archive the old contract in an archived folder. The old contract may be accessible to the end-user at the document storage page 206. In some implementations, the system 100 may also sent the new document to the third-party 218 for analysis and preparation.

Still looking at FIG. 4, the vendor dashboard 204 may include features to assist the end-user in managing reminders and notes associated with the vendor product. For example, the vendor dashboard 204 may include an option to display all of the reminders (422) associated with a given vendor.

The vendor dashboard 204 may include an option to attach and view notes and correspondences (424) (e.g. electronic mail) associated with the vendor. In some implementations, the system 100 may present the information as a list that includes the dates that the note was created, a title for the note, a note type, a product name, an identifier of the end-user that created the note, a vendor name, a product name, and a note message. The list may be filed, sorted, or organized using the note title, the email information, or by the product information.

### Document Storage

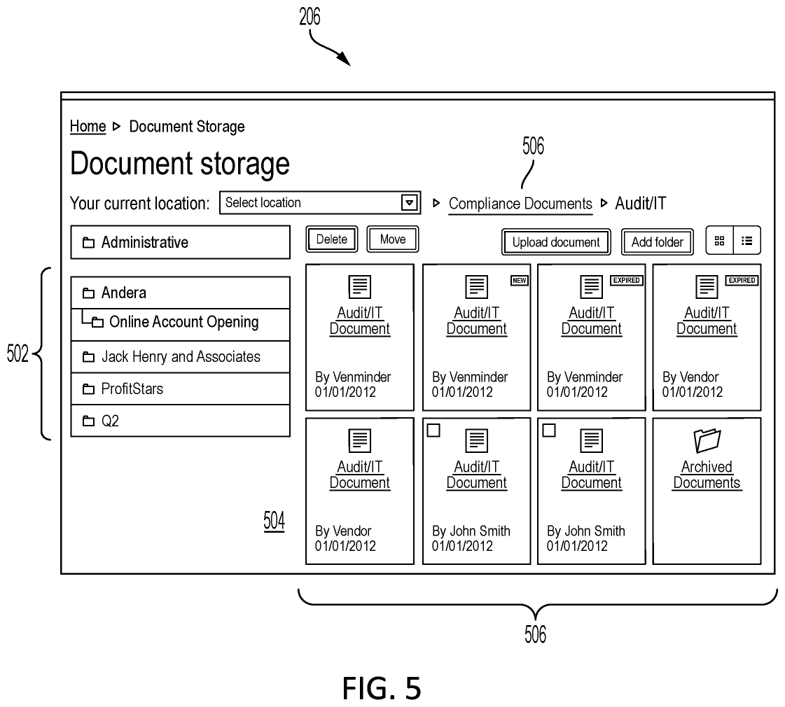

FIG. 5 is an example document storage page 206 in accordance with an embodiment of the invention. The document storage page 206 allows an end-user or product manager to view and manage documents associated with a given vendor.

In some implementations, the document storage page 206 may display a list of product managers 502 and the documents they are managing or collecting. The document storage page 206 may include a workspace 504 for managing and viewing a set of collected documents. The workspace 504 may allow the end-user to organize the set of documents in a set of vendor folders. The vendor folders may include documents and folders associated to a given vendor and vendor product.

In some implementations, the document storage page 206 may include a compliance document folder 506 to be used for the examination preparation effort. The compliance document folder 506 may include folders relating, for example, to “audit/IT”, “business continuity”, “financial”, “insurance”, “miscellaneous”, “policy”, and “product management.”

Upon a selection to upload a new document, the document storage page 206 may prompt the end-user for a file to upload, a document description, a document date, comments, and/or reminders.

The document storage page 206 may restrict the transfer of files. In some implementations, once a document has been uploaded, for example, to the compliance document folder 506, the document storage page 206 may prohibit the end-user from moving these documents to a different folder. To this end, the system 100 may require the end-user to delete the file and re-upload the file to the different folder. In some implementations, the document storage page 206 prohibits the addition of new folders to the compliance document folder 506.

As another example, only documents uploaded by the end-user may be moved by the end-user. The document storage page 206 may indicate to the end-user the documents that they have permission to move. The document storage page 206 may indicate the owner of the document.

The document storage page 206 may label the various uploaded documents. For example, in some implementations, the document storage page 206 may label documents that have been newly uploaded by the third-party 218 or by the vendor as “new”. The label may appear only during a first login session by the end-user, and the label may be removed in subsequent sessions. Other labels may include “expired.”

### Exam Preparation

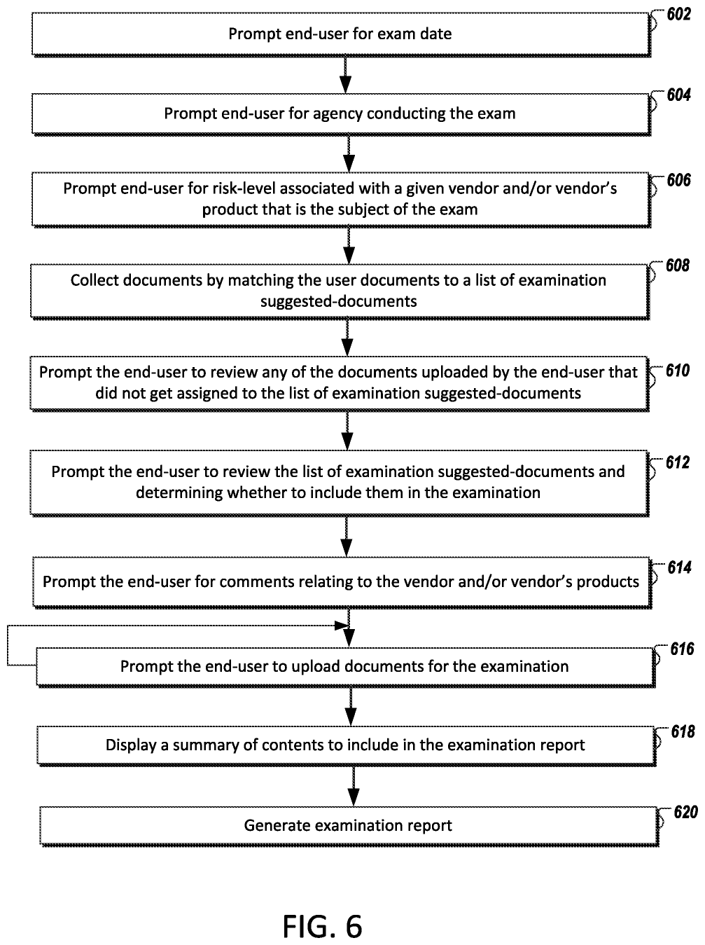

FIG. 6 is an example workflow of the system 100 to guide an end-user to prepare a vendor oversight report associated with one or more selected vendor products in accordance with an embodiment of the invention. The workflow may be referred to as “Exam Prep”. The Exam Prep may be used to assist and guide the users of a financial institutions to prepare, for example, for its annual exam with a given government agency, regulatory body, or auditing process. In some implementations, the Exam Prep may collect all of the documents that will be the subject of the examination. The Exam Prep may collect all of the notes and correspondences associated with a product. The Exam Prep may allow the end-user to review all of these documents. The Exam Prep may allow end-users to invite experts and/or collaborators to assist with the exam preparation. The Exam Prep may create or generate a report for the examiners.

In some implementations, the Exam Prep workflow may be initiated from the main dashboard 202 or the vendor dashboard 204, as described in relation to FIGS. 3 and 4.

Upon initiation of the Exam Prep workflow, the system 100 may prompt the end-user for examination information, including, for example, a date of the next regulatory exam (step 602). The system 100 may use the provided date to track the number of days remaining until the examination and to determine when notification (e.g., by email) regarding the examination may be sent. In some implementations, the system 100 may send, for example, a reminder to an end-user that created the report (and/or the product manager) 90 days before the examination. The reminder may indicate to the end-user that the report is ready for the end-user's review. The system 100 may also send a reminder, when no report has been generated, to an end-user to remind them to start a report.

In the Exam Prep workflow, in some implementations, the system 100 may prompt the user for a list of one or more agencies to be included in the examination (step 604). Examples of the agencies may include, for example, but not limited to, the Consumer Financial Protection Bureau (CFPB), Federal Deposit Insurance Corporation (FDIC), Federal Reserve System (FED), National Credit Union Administration (NCUA), and/or the Office of the Comptroller of the Currency (OCC).

In some implementations, the system 100 may also prompt the end-user for a risk-level (e.g., low, medium, high, and undefined/unknown) associated with the vendor and/or vendor product, if the information has not been provided, for which the examination is being prepared (step 606). The risk-level may be an input from the risk-assessment module 214. The system 100 may use the provided risk-level to determine suggested documents for the examination-preparation process.

FIG. 7 is an example vendor examination-preparation workspace 700 in accordance with an embodiment of the invention. The workspace 700 may display a list of products 702. For each of the products 702, the workspace 700 may display the vendor name (704), the status of the examination (706), the last reported date (708), and actionable tasks 710.

The last reported date 708 may be, for example, the last time a report was created or the last time the product was examined. The status of the examination (706) may include “complete”, “in progress”, and “not started.” A list of the examination status is shown in Table 2.

TABLE 2

| Status | Description | Action |
|---|---|---|
| Complete | All steps have been completed | Review, Preview report |
| In progress | Started but not all steps | Continue, Preview |
| | completed | report |
| Not started | No steps have been started | Start |

The actionable tasks 710 may include reviewing an examination report (712), creating a report (714), continuing a report (716), and starting a report (718).

The system 100 may save all of the work, including all of the actions taken by the end-user. To this end, the end-user can continue from another point in the examination preparation process.

Referring back to FIG. 6, in some implementations, the method 600 may include matching all of the end-user's uploaded documents to a list of examination suggested documents (step 608). The list of examination suggested documents may be a pre-defined list selected from a set of pre-defined list. The pre-defined list may be selected based on the risk-level associated with the given product or vendor subject to the examination.

FIG. 8 is an example workspace 800 for matching collected end-user's document to a list of suggested documents in accordance with an embodiment of the invention. The workspace 800 may display a list of collected documents uploaded by the end-user (802). The list may include documents collected in the compliance document folder, as described in relation to FIG. 5. The workspace 800 may display a list of suggested documents (804) for the examination. The list of suggested documents (804) may be a pre-defined list of documents that is organized by risk levels. The workspace 800 may allow the end-user to select a document from the collected list (802) and “drag and drop” it to a suggested content in the list of suggested documents (804). The action may merely associate the documents in that no files are moved.

The system 100 may display a status of the workflow (806). The status may include an indicia of the current process being performed by the end-user and a status of the other processes (e.g., complete, in-profess, or ready to start) in the workflow.

Referring back to FIG. 6, in some implementations, the method 600 may include prompting the end-user to review any of the collected documents uploaded by the end-user that was not assigned to the list of the examination suggested-documents (step 610). FIG. 9 is an example workspace 900 for prompting the end-user to review the unassigned documents 902 that has been collected to the document storage page 206, but has not been assigned in FIG. 8. In some implementations, the system 100 may prompt the end-user to identify each of the unassigned documents as either to include (904) or exclude (906) from the report/examination.

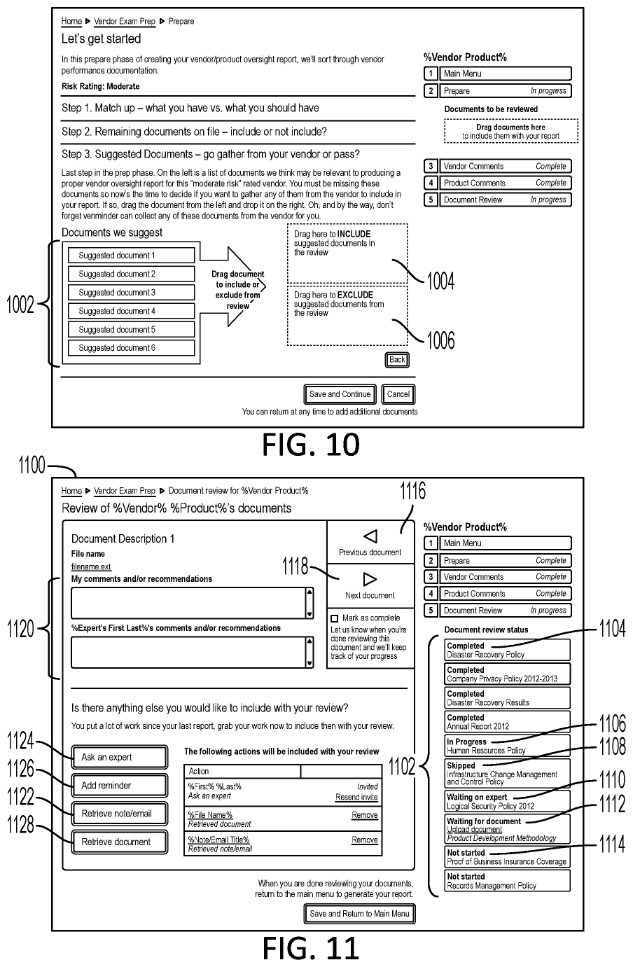

Still looking at FIG. 6, in some implementations, the method 600 may include prompting the end-user to review the list of examination suggested-documents and determining whether to include them in the examination (step 612). FIG. 10 is an example workspace 1000 for prompting the end-user to review the unassigned suggested documents 1002. The system 100 may prompt the end-user to identify each of the unassigned suggested documents as either to include (1004) or exclude (1006) from the report/examination.

Still looking at FIG. 6, in some implementations, the method 600 may include prompting the end-user to provide comments about the vendor (step 614). The comments may be in response to interrogatories, such as (i) “What has the vendor done well since your last exam date,” (ii) “What has not gone well since your exam date,” and (iii) “What actions are you going to take before your exam date.” The system 100 may also prompt the user to provide comments for each of the vendor product that is being examined.

Still looking at FIG. 6, in some implementations, the method 600 may include displaying (step 614) all of the documents that has been matched between the end-user's uploaded documents and the list of suggested documents (as described in relation to FIG. 8) as well as those documents that are marked to include (as described in relation to FIGS. 9 and 10). FIG. 11 is an example workspace 1100 for preparing the collected document for the examination report in accordance with an embodiment of the invention. The system 100 may display a status label for each of the documents. The status label may include “completed” 1104, “in progress” 1106, “skipped” 1108, “waiting for experts” 1110, “waiting for documents” 1112, and “not started” 1114. The status labels are described in further detail in table 3.

TABLE 3

| Document | |
|---|---|
| Status-Label | Description |
| Not Started | Included in exam but the user has not reviewed it |
| Waiting on expert | Expert has been invited but no response provided |
| Waiting for | Document type is included in exam but document |
| documents | has not been uploaded |
| Skipped | Viewed the document but preformed no actions |
| In Progress | Actions preformed but not marked as complete |
| Complete | Checked the box mark as complete |

In some implementations, the system 100 may provide a navigation function to allow the end-user to scroll through the various selected documents. The navigation function may include an arrow to review the previous selected document (1116) or the next selected document (1118). For each of the selected documents, the system 100 may allow the end-user to add comments (1120), to retrieve an electronic correspondence or note (1122), to invite an expert and/or collaborator to provide comments or to assist in the document preparation (1124), and/or to set reminders (1126).

Upon selection to invite a co-worker/expert (1124), the system 100 may provide a list of co-workers and/or suggested experts for the user to send a message. The system 100 may also prompt the end-user for a name, contact information, and a message to send to a co-worker and/or expert. The system 100 may accept multiple requests for comments.

The system 100 may allow each of the co-workers and/or experts to register and login. After which, the system 100 may only allow the co-worker and/or expert to view and provide comments for the vendors and/or vendor product to which they were asked for comments. The system 100 may send a notification to the end-user subsequent to a comment being provided. The system 100 may also send a notification when the co-worker and/or expert has registered to the system 100.

Upon receipt of comments from a given co-worker and/or expert, the system 100 may label the request as being complete. The system 100 may also update the Exam Prep workspace 1100 with the received solicited comments. To this end, the system 100 may provide an organized and efficient framework to request for comments from internal and external collaborators, to track such requests, and to review and utilize such comments in the examination-preparation process.

Upon selection of an input to retrieve an electronic correspondence or note (1122), the system 100 may display a list of notes and correspondences stored within the system 100. The system 100 may provide a date, a title, a correspondence type (e.g., email, notes, SMS, etc.), and an identity of the end-user and/or product manager that performed the uploaded. The system 100 may allow the end-user to filter the list based on the correspondence type.

Still looking at FIG. 11, the system 100 may allow the end-user to retrieve additional documents (1128) related to the vendor product. A selection of this input (1128) may direct the end-user to the document storage page 206, as described and shown in relation to FIG. 5. The end-user may add documents to the examination preparation process from there.

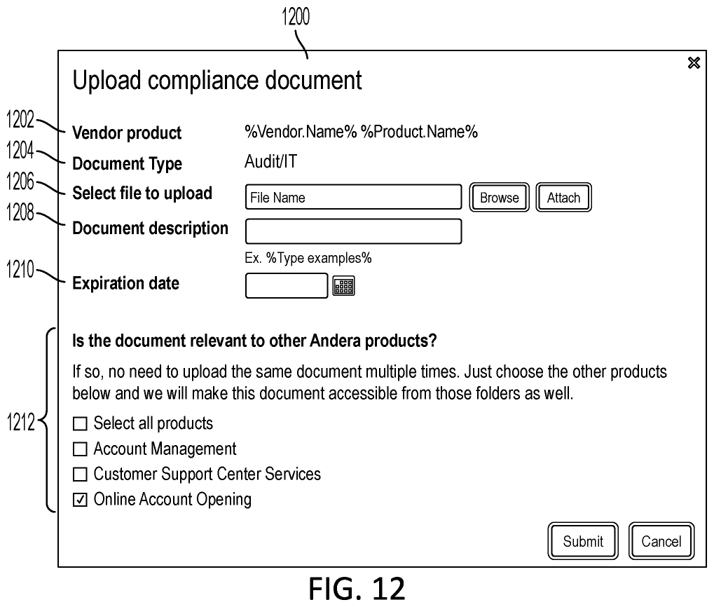

Referring back to FIG. 6, in some implementations, the method 600 may include prompting the end-user to upload documents for the examination (step 616). FIG. 12 is an example workspace 1200 for uploading document to be attached and included in the examination in accordance with an embodiment of the invention. The workspace 1200 may display the vendor product name 1202 and the document type 1204. The workspace 1200 may prompt the end-user for a file (1206), a document description (1208), an expiration date (1210), and a selection to use the document for other products (1212). The selection (1212) allows the end-user to have to upload a given document only once as the document can be applied to multiple products that may be the subject of one or more examinations. The workspace 1200 also allows the end-user to tailor comments and descriptions for each of the documents to be included in the report.

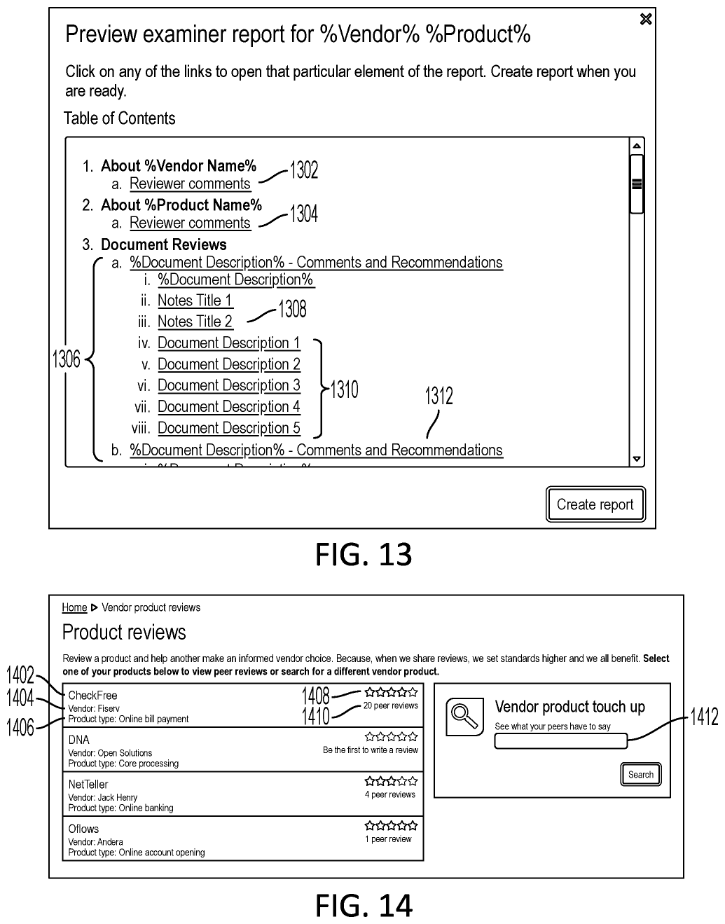

Still looking at FIG. 6, in some implementations, the method 600 may include displaying a summary of contents to include in the examination report (step 618). FIG. 13 is an example workspace 1300 to preview contents to be included in the examination report. The contents may include, for example, but not limited to, the reviewer's comments about the vendor (1302), the reviewer's comments about the products (1304), and the documents to include in the report (1306). The documents 1306 may include notes (1308), documents (1310), and comments and recommendations (1312). The system 100 may allow the end-user to preview any of the uploaded documents, comments, and notes as collected by the system 100.

Still looking at FIG. 6, in some implementations, the method 600 may include generating an examination report in accordance with an embodiment of the invention (step 620). The report may be generated, for example, as a PDF (“portable document format”) file. In some implementations, the report may be generated as a compressed file (e.g., a ZIP (archive file format) file). Upon a creation of the examination report, the system 100 may add the report to an archive section to which the end-user can later review the report. The system 100 may also update the vendor and product dashboard to indicate the recent addition of a new report as well as the status of the last instance that a report had been created. In some implementations, the system 100 may send a notification to the end-user to recommend initiating a new report (in the case of an annual report). The notification may be sent, for example, 9 months after the examination report has been generated.

### Vendor Product Review

The system 100 may include a vendor product review workspace to allow the end-user to view and provide reviews/ratings for a given vendor, as described in relation to FIG. 3. In some implementations, the system 100 may display the performance rating and/or the listing of one or more performance comments received from users of the given vendor product and/or one or more corresponding products provided by one or more different vendors.

FIG. 14 is an example workspace 1400 to review vendor products in accordance with an embodiment of the invention. The workspace 1400 may display, at any given instance, a composite of multiple vendor products. The composite may include preferably four to five vendor products. Of course, any of number of vendor products may be displayed on the workspace 1400. For each of the products, the workspace 1400 may display the vendor name (1402), the product (1404), the product type (1406), a rating value 1408, and an indication of the number of reviews (1410). In some implementations, the system 100 may provide a search tool 1412. In some implementations, the system 100 may also provide a rating/review module for a given vendor.

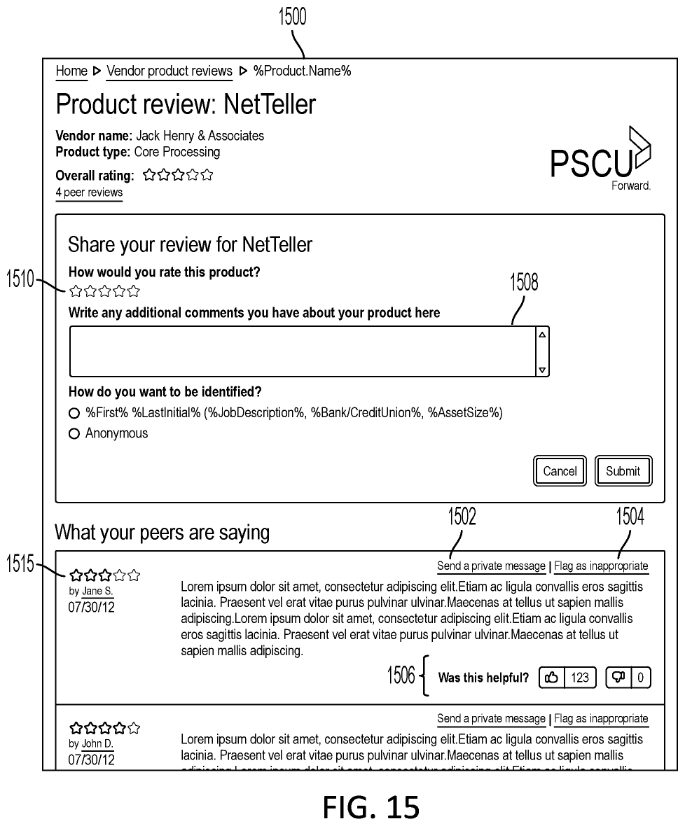

FIG. 15 is an example display 1500 for viewing product reviews in accordance with an embodiment of the invention. In some implementations, the system 100 may provide a prompt 1502 for the end-user to send a private message to the vendor or to the reviewer. The system 100 may also provide a prompt 1504 to flag the review as being inappropriate. The flag may generate a notification to a designated reviewer to determine whether the message is appropriate to display. The system 100 may also display an indicator of the number of people that flagged the review as being helpful and/or unhelpful.

The system 100 may prompt the end-user to provide a review 1508 for a given selected product. The end-user may provide a rating value 1510 (which may a star rating), comments, and identifier/contact information.

In some implementations, the display 1500 may include a listing of performance ratings (1512) received from various end-users and/or product managers of the various vendor products. The listing may be organized (e.g., ordered) on the graphical user interface according to popularity (e.g., number of “likes” received for each of the performance comments).

### News and Alerts

The system 100 may include an alert and/or information feed that provides information about changes that have been made (e.g., new documents uploaded, new reviews added, and status updates for a given examination or preparation process, etc.). The alert may include a progress bar to indicate a given end-user progress with a given task.

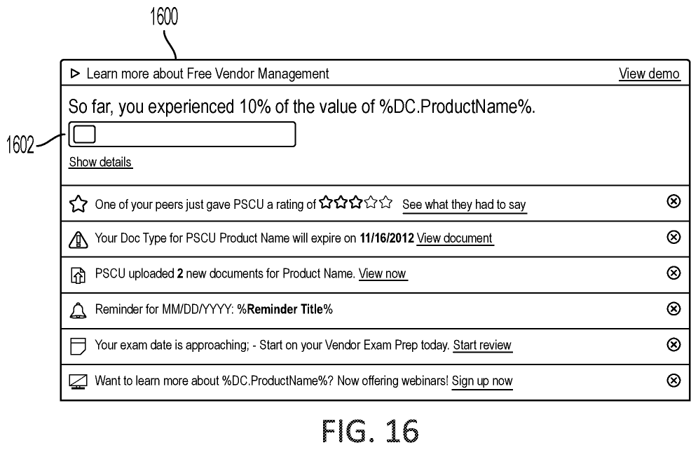

FIG. 16 is an example alert and information display 1600 in accordance with an embodiment of the invention. The display 1600 may include an experience bar 1602 that shows a given user's level of experience with the system 100. The system 100 may calculate the experience bar based on a set of tasks or functions performed by the end-user within the system 100. Each function may be assigned a function value, which may be aggregated to produce a total experience value. The experience bar 1602 may display the total experience value to the user. Examples of assigned values for a set of functions are provided in Table 4.

TABLE 4

| Function | Link | Percentage |
|---|---|---|
| Add Contract | Upload Contract | 10% |
| Add 2 Compliance Documents | Document Storage | 5% each |
| Add a vendor product | Add Vendor Product | 10% |
| Add a collaborator | Vendor Dashboard | 10% |
| Attach an email and Note | Emails and Notes | 5% each |
| Add a reminder | Reminders | 10% |
| Preform Exam Prep | Exam Prep | 20% |
| Write a review | Vendor Product Review | 10% |

### Onboarding Module

In another aspect of an embodiment, system 100 provides an onboarding module as described herein to vet, approve, and/or decline one or more vendors and/or their products/services. This module may be suitable for organizations that undergo a procurement process prior to adding vendor product/services to their vendor lists for ongoing oversight.

In some embodiments, a user (e.g., a client user) whose purchase plan specifies the vendor onboarding software module may have access to this module. A user (e.g., an admin user and/or VMO user) may control how vendors and their products are processed, e.g., with the creation of custom forms, e.g., via one or more suitable GUIs, and/or exempt product categories. In some embodiments, after a vendor request is submitted, a user (e.g., client user) may perform some or all of the same actions necessary to properly vet the request and ensure the vendor is the right choice for their organization.

### Vendor Onboarding Settings

In some embodiments, a user (e.g., an admin user and/or VMO user) may have the possibility and/or may be provided the means necessary (e.g., permission granted by the system) to access the settings area of the vendor onboarding module. In some embodiments, within the settings area, a user may manage one or more of the following functions and/or submodules.

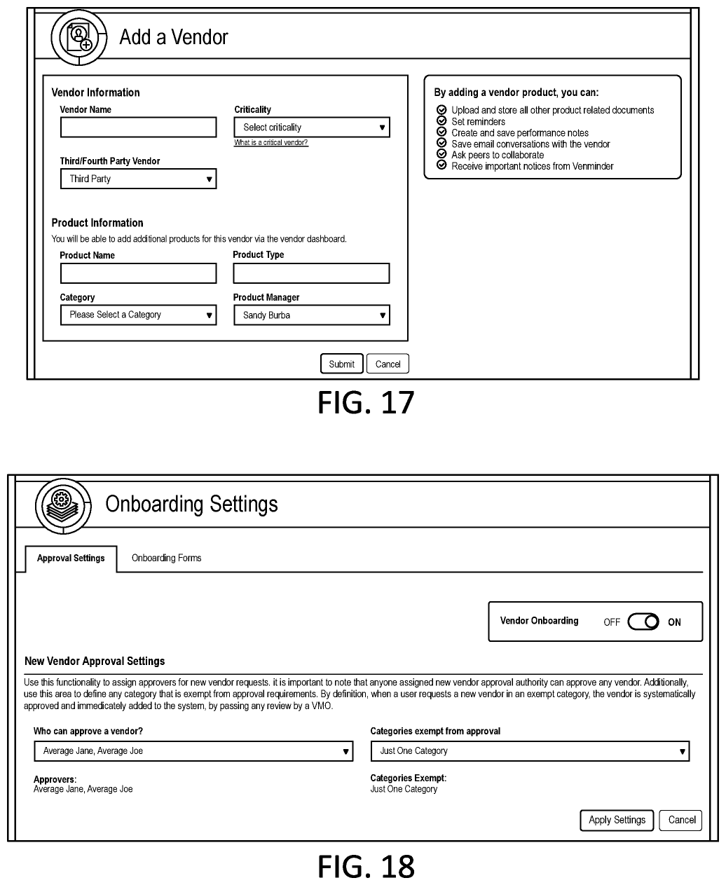

Turn Vendor Onboarding Off or On. With vendor onboarding set to “off”, one or more vendors may be added immediately into the system (e.g., system 100) using the systems standard add a vendor form, e.g., as shown in FIG. 17. With vendor onboarding set to “on”, one or more vendor requests may be handled based on the users (e.g., client user's) vendor onboarding settings.

### VMO/Who can Approve a Vendor Request.

In some embodiments, any user who is active (e.g., invited and/or enrolled) may be assigned a VMO role. In some embodiments, the system may be configured such that a minimum of two users are required to have been assigned the VMO role in order to turn on/activate vendor onboarding. This may ensure that there is at least one (e.g., second) eligible VMO user designated to approve a request if the request was submitted by another (e.g., first) VMO user. In some embodiments, the VMO role/permission may also be managed from within an admin panel (e.g., a panel GUI) (client experience) and/or a client support panel (e.g., a panel GUI) (admin experience).

Exempt Product Categories. In some embodiments, product categories may be made exempt from vendor onboarding. In some embodiments, a vendor request is auto-approved by the system, e.g., without user action (e.g., a vendor product/service may be added to the system without requiring review and approval by a VMO). An example vendor onboarding settings: approval settings GUI is shown in FIG. 18. In some embodiments, a VMO may choose categories that are exempt from needing approval during onboarding. For example, vendors that fall into the category of exempt (meaning they are exempt from needing approval (i.e., by a VMO) to be on-boarded) may include: caterers, custodial/janitorial vendors, basic maintenance technicians/vendors, etc. On the other hand, in some embodiments, categories may be defined for critical vendors (IT, specialists, security, legal, etc.) where VMO approval is always required during onboarding. In some embodiments, multiple VMOs may be assigned to and/or associated with a single vendor (for example, taking responsibility for different aspects or products of that single vendor). In embodiments where multiple VMOs are assigned to a single vendor, approval from only a single VMO is required during onboarding. In some embodiments, where the total services rendered by a vendor are expected to not exceed a finite (for example, small) dollar amount (for example, $100, $500, $1000, etc.) a vendor, a vendor may be able to be on-boarded regardless of vendor category. Such vendors may require subsequent approval if the value of the services rendered exceeds the expected amount during onboarding.

### Forms

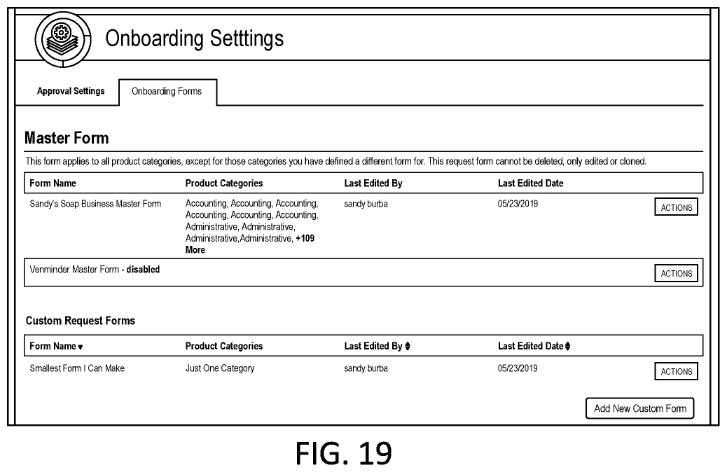

In some embodiments, the system may provide (e.g., via a GUI) a default/suggested form, e.g., a so-called master form. In some embodiments, a user (e.g., a client user) may create a new form or a modified master form. In some embodiments, a master form may be a “catch all” form for product categories that do not have a custom form associated with them. In some embodiments, the system may be configured to allow a user (e.g., a client user) to have (e.g., have access to and have be associated with) one active master form. In some embodiments, a user (e.g., a client user) may create as many custom forms as they have product categories. One or more custom forms may be linked to multiple product categories. An example vendor onboarding form GUI is shown in FIG. 19.

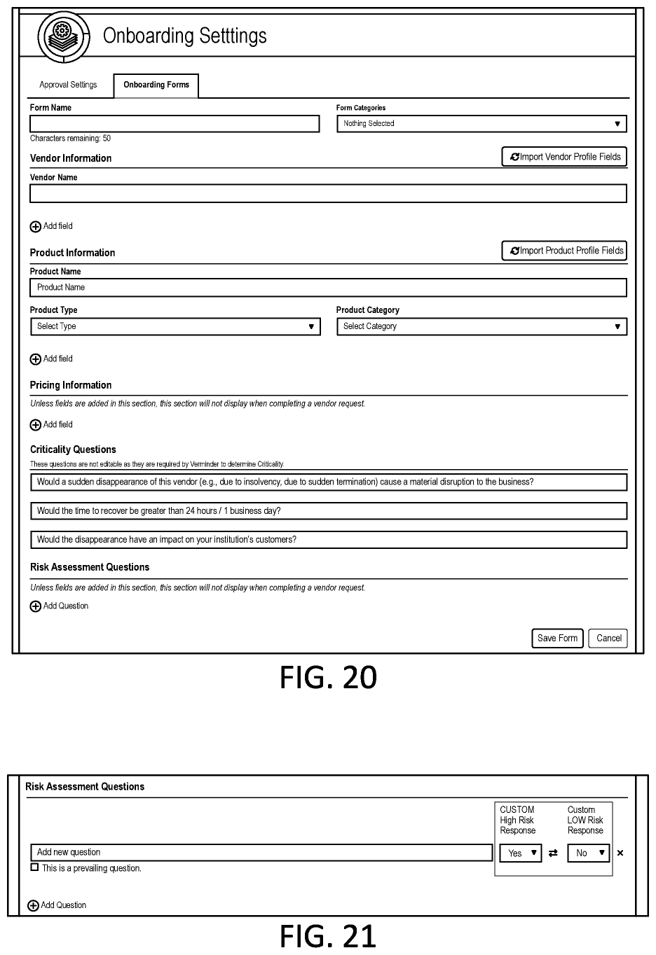

In some embodiments, the system may be configured such that at least a form contain vendor name, product name, product type, and/or criticality are required. In some embodiments, a criticality assessment section of a form may use the same questions as those on a standard “add a vendor” form. In some embodiments, the system may set the vendor to “critical” if ‘Yes’ is selected in response to any one of questions on a vendor request form (e.g., via an appropriate vendor request form GUI). An example vendor request form GUI (e.g., with minimal fields) is shown in FIG. 20.

In some embodiments, if a user (e.g., a client user) elects (e.g., by making an appropriate selection on a GUI) to use the optional risk assessment section on a vendor request form, a form may use a limited amount of functionalities found within a risk assessment module. In some embodiments, such functionalities may include the options to mark a question as a prevailing question, presentation of only the highest and lowest risk levels, and/or presentation of only Yes/No answer formats, but with the possibility to switch between answers and/or risk levels. An example risk assessment section of a request form GUI is shown in FIG. 21.

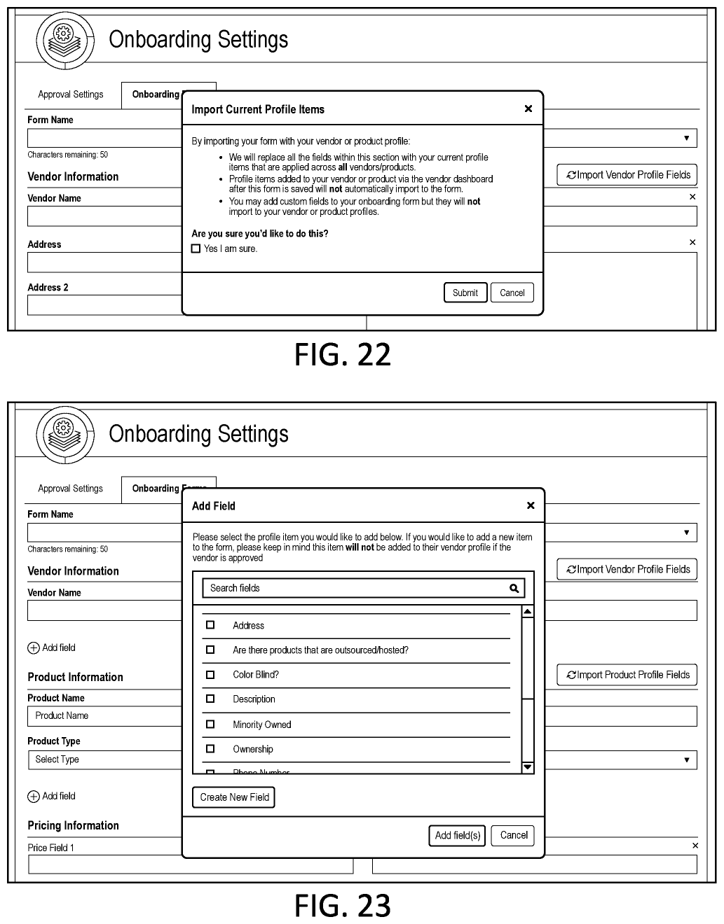

In some embodiments, if a user (e.g., client user) edits and/or creates a form, the user may import some or all vendor and product profile items from a vendor dashboard, or may select which profile items may be included on a form. An example import profile items GUI is shown in FIG. 22. An example profile item selection GUI is shown in FIG. 23.

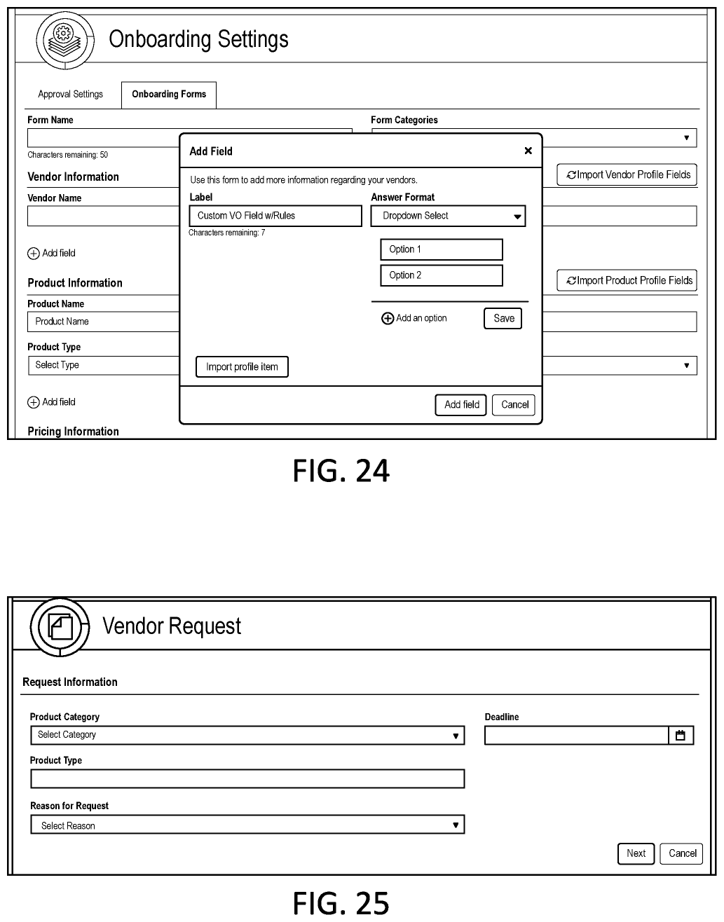

In some embodiments, a user (e.g., a client user) may create custom onboarding request items that will only appear on the onboarding request form for which the user is creating or editing. In some embodiments, this custom field may be configured with answer formats and/or tiered form fields. An example custom onboarding form field is shown in FIG. 24.

### Request A Vendor/Add a Vendor

In some embodiments, when a vendor onboarding module is active (e.g., set to “on”), when a user (e.g., a client user) adds a vendor and/or requests a vendor, the user may complete a preliminary form where the user may specify a product category, deadline (e.g., if applicable/optional), product type, and/or the reason for the request (e.g., requesting bid for a new product/service or requesting bid for an existing product/service). If the request is for a new product/service, a user (e.g., a client user) may elect to include information relating to a current vendor, and if the request is for an existing product/service, the user may elect to include information relating to an incumbent vendor. In some embodiments, the incumbent vendor may be included in a request, e.g., in scenarios in which a client user plans to replace the (incumbent) provider of the product/service. In the event that a user completing the form is unaware of current or incumbent vendors, when the user begins entering a value in the vendor name field and/or the product name field, the system may populate (e.g., automatically without user interaction) current or incumbent vendors and products in the applicable fields and update request information accordingly, e.g., to maintain accuracy for the vendor request. An example request a vendor preliminary form GUI is shown in FIG. 25.

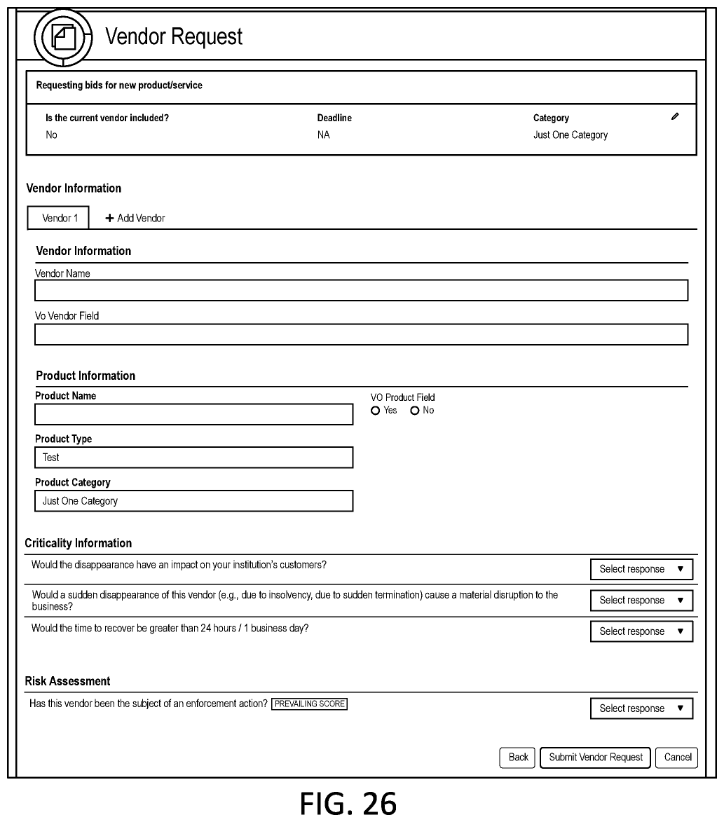

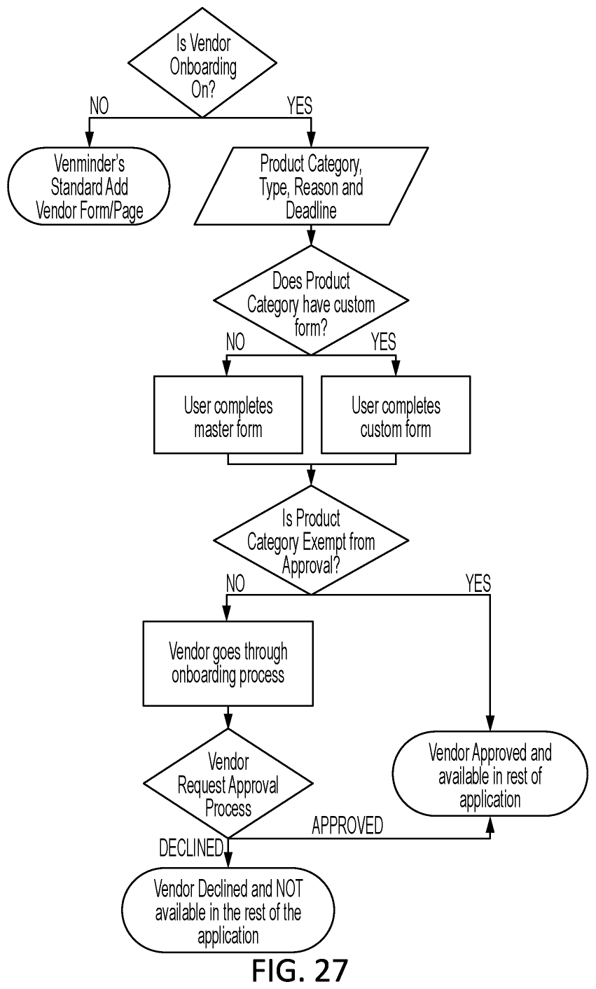

In some embodiments, once initial information is submitted, the system may present the appropriate form (e.g., via an appropriate GUI) based on a product category selected. In some embodiments, if a current or incumbent vendor is included on the request and the form has profile items imported, the system may populate (e.g., automatically without user interaction) the form with existing data on file for the vendor and/or product. In some embodiments, the form may not be editable. In some embodiments, within the onboarding module, if a product belongs to an exempt category, the product may be exempt from undergoing the full onboarding workflow. Such a product may be automatically marked as approved once the initial form is submitted. In some embodiments, after completion of the onboarding and/or within the remainder of the system, a product belonging to an exempt category may be exempt from performing oversight tasks. In some embodiments, if the product category is exempt, only one vendor may be requested. In some embodiments, if the product category is not exempt, a vendor request may have multiple vendors within a single request. An example request a vendor GUI is shown in FIG. 26. An example vendor request flow diagram is shown in FIG. 27.

### Vendor Requests

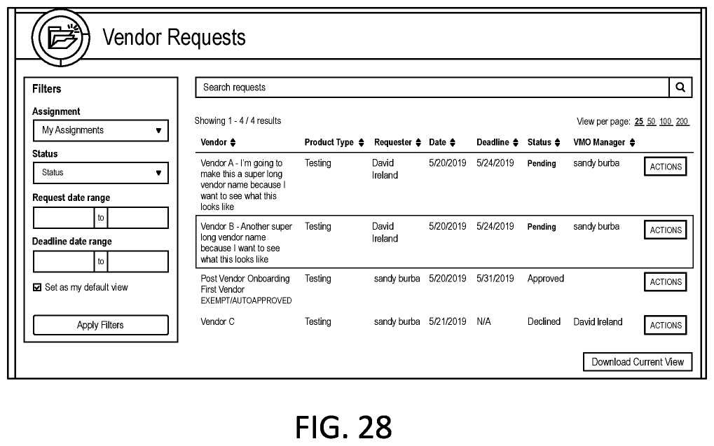

In some embodiments, any vendor request submitted with the vendor onboarding module active (“on”) may be accessible within a vendor requests area (e.g., via an appropriate GUI). However, whether and to what extent a user (e.g., a client user) may be presented with and/or have access to a request may depends on the user's role. For example, a user that is not a VMO may be presented with the user's own vendor requests (e.g., as read only), but not other users' vendor requests, unless the user is assigned to complete work within the request. A user that is a VMO may see all vendor requests (e.g., as editable requests), but the user's own vendor request may be “read only” unless the user is assigned to complete work within the request. An example vendor request GUI is shown in FIG. 28.

### ‘Is On-Boardable’ Flag Set to True

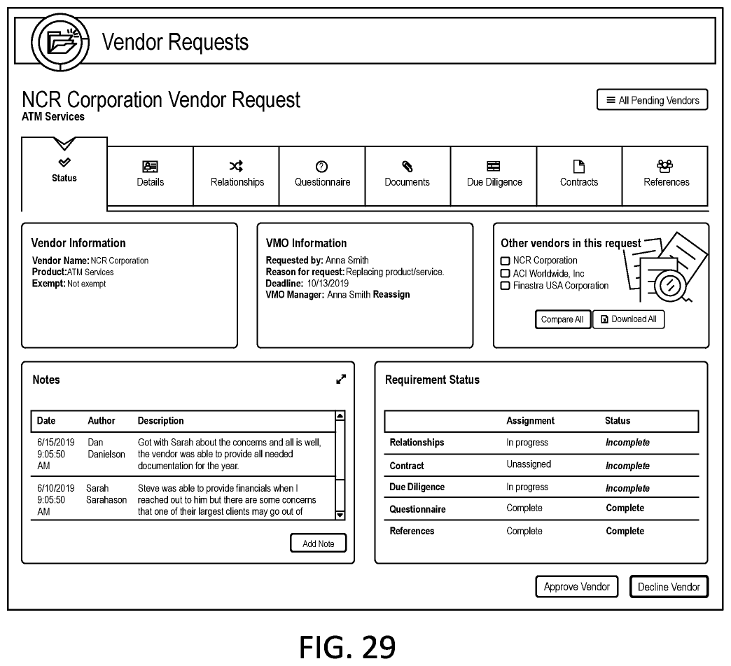

In some embodiments, new vendors going through vendor onboarding for approval may have assigned a flag within the database called ‘is on-boardable’ that is set to “true”. If this flag is set to “true” (e.g., via an appropriate GUI), the system may suppress (e.g., deny access and/or read/write options) the vendor information and activity associated with the vendor, e.g., from a core application area. In some embodiments, this flag may only appear within the vendor onboarding module. Current or incumbent vendors/products that are included on a vendor request may continue to be accessible throughout the system application, but work done within vendor onboarding may only be accessible within the vendor onboarding module (e.g., access from the remainder of the system may be denied). An example view vendor request form is shown in FIG. 29. In some embodiments, a vendor request (e.g., a vendor request GUI) may include the areas/tabs shown in Table 5:

TABLE 5

| | |
|---|---|
| Status | An overview area that provides vendor information, VMO |
| | information, a note area, a requirement status overview and a |
| | comparison area when there is more than one vendor on a request. |
| Details | Vendor and product information captured from the request/form. |
| | Data populated on the vendor request form as a result of a current or |
| | incumbent vendor/product may not be edited (e.g., editing may be |
| | denied). If not a current or incumbent vendor, the form fields may be |
| | updated during onboarding. |
| Relationships | Fourth party relationship information may be stored here. |
| | A current or incumbent vendor/product may have (be associated |
| | with) fourth party information retrieved from the vendor dashboard. |
| Questionnaire | This area may allow access to questionnaire module functionality. |
| | A current or incumbent vendor/product may have (be associated |
| | with) completed questionnaires retrieved from the questionnaires |
| | module. |
| Documents | Documents may be stored in this area while the vendor request is |
| | going through vendor onboarding. |
| | A current or incumbent vendor/product may have documents brought |
| | over from document storage. |
| Due Diligence | Due diligence (oversight requirement) tasks are managed and |
| | completed. |
| | A current or incumbent vendor/product may have in-progress and |
| | completed tasks brought over from the oversight management |
| | module. |
| Contracts | Contract documents may be stored while the vendor request is going |
| | through vendor onboarding. |
| | An active contract for a current or incumbent vendor/product may be |
| | accessed from here. |
| References | Record recommendations from references provided by the vendor. |
| | This data may be isolated only to the vendor request and may only be |
| | found in vendor onboarding. |

### Comparison View.

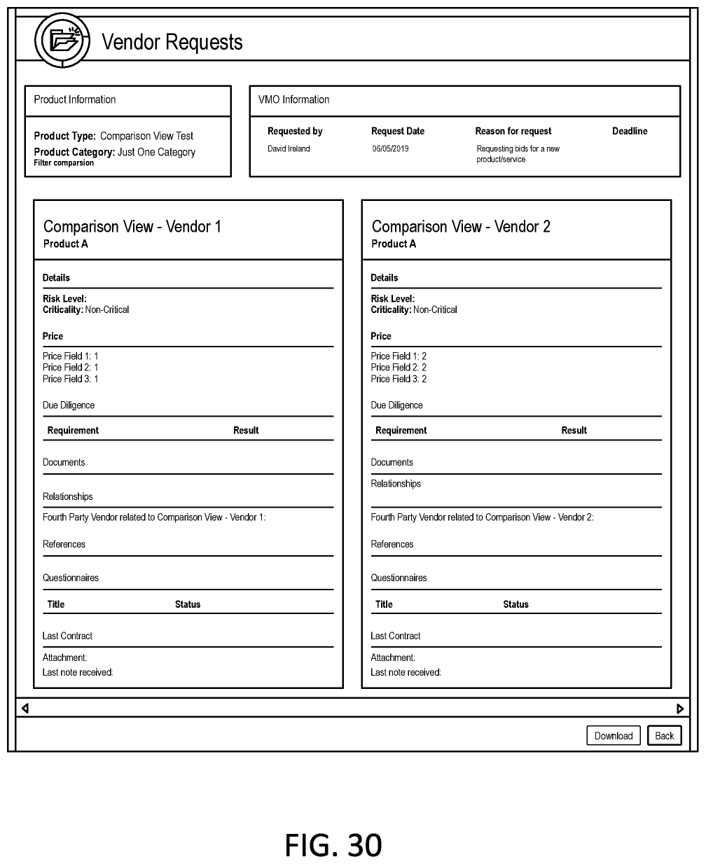

In some embodiments, when a request is associated with multiple vendors, a status tab may include an area that lists other vendors. A user may elect to compare all or only certain vendors on the request, e.g., via an appropriate GUI. In some embodiments, the system may aggregate request information across multiple vendors providing a side-by-side comparison view, e.g., via an appropriate GUI. An example vendor request form GUI with comparison view is shown in FIG. 30.

### Section/Requirement Assignment.

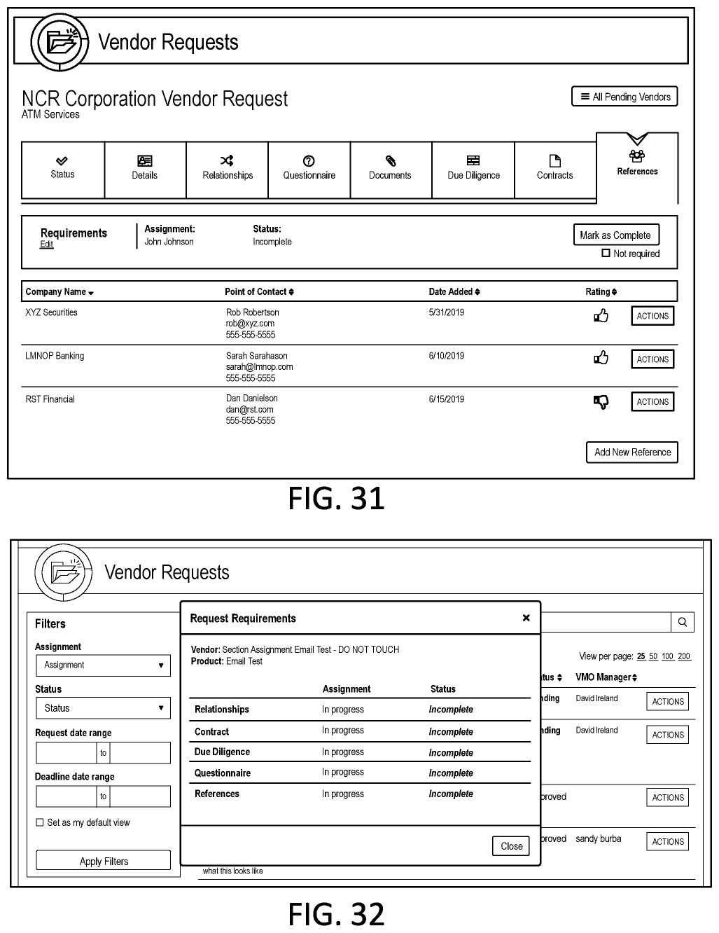

In some embodiments, within a request form, a user, e.g., a VMO user, may assign a user to complete one or more sections/requirements or may mark a section/requirement as not required. In some embodiments, sections include relationships, contract, due diligence, questionnaire, and/or references. An example requirements status bar on a vendor request form is shown in FIG. 31.

In some embodiments, requirement status overview is available on the status tab as well as from a list of vendor requests, e.g., by clicking on the status of a pending vendor request on an appropriate GUI. An example requirements status overview GUI is shown in FIG. 32.

### Approving/Declining A Vendor Request

Declining a Vendor Request. In some embodiments, if a vendor request is declined, the request may be accessible within the vendor onboarding module only. The request may not appear throughout the system application. In some embodiments, a declined vendor request may be reactivated, and previous work may remain intact. In some embodiments, if a vendor request contains multiple vendor products and one vendor product is declined, the remaining vendor product(s) may remain in (active) pending onboarding status. In some embodiments, if a declined vendor request is related to a current or incumbent vendor, the declined vendor request may not affect a record that is already in the system application. In some embodiments, to deactivate a vendor product, a user (e.g., a client user) may (or must) access the vendor dashboard to manage product status.

### Approving a Vendor Request.

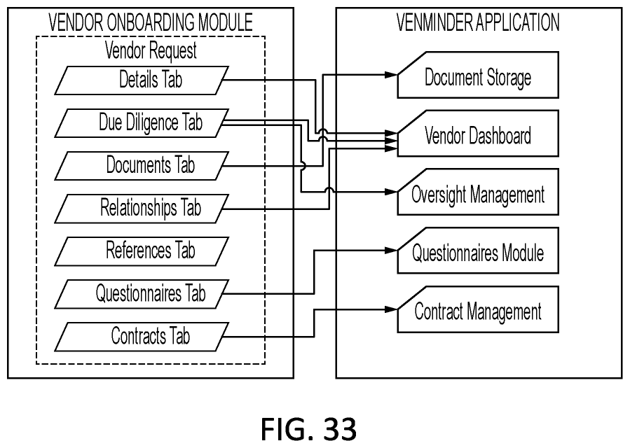

In some embodiments, if a vendor request is approved, data stored at the request level may be distributed throughout the system application. As a part of this distribution process, selected contract documents may be sent straight (e.g., automatically) into contract processing. In some embodiments, a vendor request may remain accessible within the vendor onboarding module. In some embodiments, if a vendor request contains multiple vendor products and, e.g., one is approved, the other vendor products associated with one or more other vendors in the request may be automatically declined. In some embodiments, if the approved vendor request is related to a current or incumbent vendor, the work completed as a result of the vendor request may be updated (e.g., automatically) throughout other areas of the system application. A diagram illustrating the mapping from vendor onboarding to other areas of the system application is shown in FIG. 33.

### Email Notifications

In some embodiments, the vendor onboarding module may create notifications (e.g., automatically, e.g., by automatically generating and/or sending one or more email messages) when certain activities occur to alert one or more responsible individuals. Example emails and their respective triggers are shown in Table 6:

TABLE 6

| Email Template | Description | Trigger |
|---|---|---|
| Vendor Onboarding | Sent to client's active and enrolled | Client turns vendor |
| Activated | users with the VMO role to inform | onboarding on |
| | them that vendor onboarding has | (Settings in Vendor |
| | been turned on. | Onboarding module) |
| Vendor Onboarding | Sent to client's active and enrolled | Client turns vendor |
| Deactivated | users with the VMO role to inform | onboarding off |
| | them that vendor onboarding has | (Settings in Vendor |
| | been turned off. | Onboarding module) |
| Vendor Request | Sent to a user who is the requestor | Vendor request approved |
| Approved | and the user who approved the | (Status tab when viewing a |
| | vendor request to inform them that | vendor request) |
| | the vendor request was approved. | |
| Vendor Request | Sent to the user who is the requestor | Vendor request declined |
| Declined | to inform them that the vendor | (Status tab when viewing a |
| | request was declined. | vendor request) |
| Vendor Request Section | Sent to user assigned to complete a | Requirement/Section |
| Assignment | section within a vendor request to | assignment and every 3 |
| | remind them they have work to do. | business days until section is |
| | | marked as complete or not |
| | | required. |
| New Vendor Requests | Sent to active and enrolled users | Daily (AM) when there are |
| | with the VMO role to inform them | vendor requests in new status |
| | that there are new vendor requests. | |

### Exemplary Network Environment and Computing Device

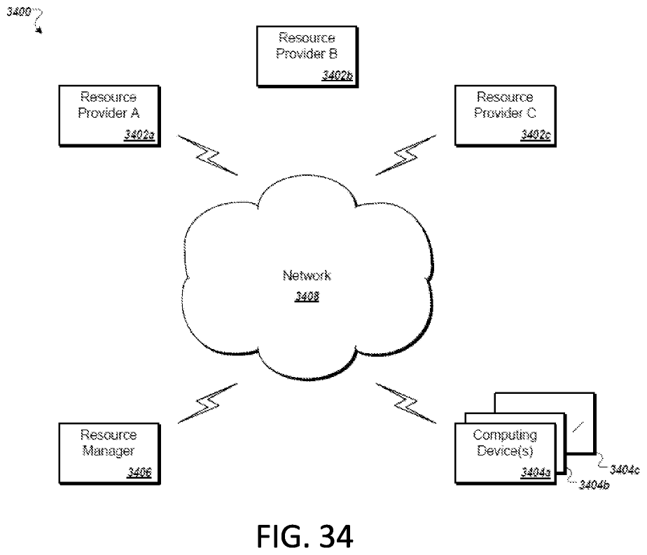

FIG. 34 shows an illustrative network environment 3400 for use in the methods and systems described herein. In brief overview, referring now to FIG. 34, a block diagram of an exemplary cloud computing environment 3400 is shown and described. The cloud computing environment 3400 may include one or more resource providers 3402a, 3402b, 3402c (collectively, 3402). Each resource provider 3402 may include computing resources. In some implementations, computing resources may include any hardware and/or software used to process data. For example, computing resources may include hardware and/or software capable of executing algorithms, computer programs, and/or computer applications. In some implementations, exemplary computing resources may include application servers and/or databases with storage and retrieval capabilities. Each resource provider 3402 may be connected to any other resource provider 3402 in the cloud computing environment 3400. In some implementations, the resource providers 3402 may be connected over a computer network 3408. Each resource provider 3402 may be connected to one or more computing device 3404a, 3404b, 3404c (collectively, 3404), over the computer network 3408.

The cloud computing environment 3400 may include a resource manager 3406. The resource manager 3406 may be connected to the resource providers 3402 and the computing devices 3404 over the computer network 3408. In some implementations, the resource manager 3406 may facilitate the provision of computing resources by one or more resource providers 3402 to one or more computing devices 3404. The resource manager 3406 may receive a request for a computing resource from a particular computing device 3404. The resource manager 3406 may identify one or more resource providers 3402 capable of providing the computing resource requested by the computing device 3404. The resource manager 3406 may select a resource provider 3402 to provide the computing resource. The resource manager 3406 may facilitate a connection between the resource provider 3402 and a particular computing device 3404. In some implementations, the resource manager 3406 may establish a connection between a particular resource provider 3402 and a particular computing device 3404. In some implementations, the resource manager 3406 may redirect a particular computing device 3404 to a particular resource provider 3402 with the requested computing resource.

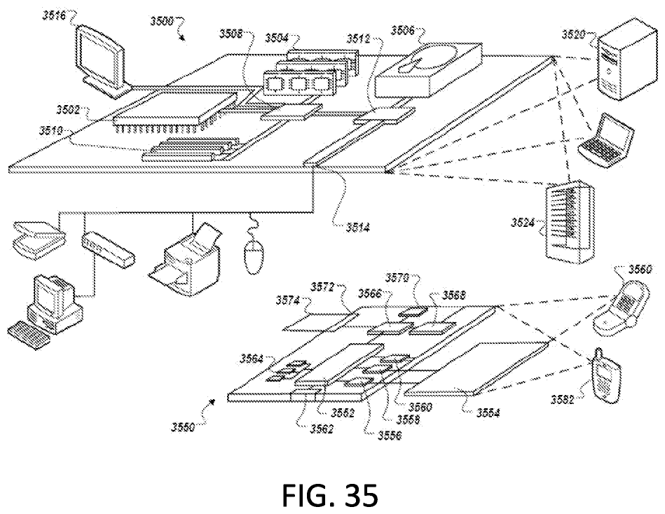

FIG. 35 shows an example of a computing device 3500 and a mobile computing device 3550 that can be used in the methods and systems described in this disclosure. The computing device 3500 is intended to represent various forms of digital computers, such as laptops, desktops, workstations, personal digital assistants, servers, blade servers, mainframes, and other appropriate computers. The mobile computing device 3550 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 3500 includes a processor 3502, a memory 3504, a storage device 3506, a high-speed interface 3508 connecting to the memory 3504 and multiple high-speed expansion ports 3510, and a low-speed interface 3512 connecting to a low-speed expansion port 3514 and the storage device 3506. Each of the processor 3502, the memory 3504, the storage device 3506, the high-speed interface 3508, the high-speed expansion ports 3510, and the low-speed interface 3512, are interconnected using various busses, and may be mounted on a common motherboard or in other manners as appropriate. The processor 3502 can process instructions for execution within the computing device 3500, including instructions stored in the memory 3504 or on the storage device 3506 to display graphical information for a GUI on an external input/output device, such as a display 3516 coupled to the high-speed interface 3508. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 3504 stores information within the computing device 3500. In some implementations, the memory 3504 is a volatile memory unit or units. In some implementations, the memory 3504 is a non-volatile memory unit or units. The memory 3504 may also be another form of computer-readable medium, such as a magnetic or optical disk.

The storage device 3506 is capable of providing mass storage for the computing device 3500. In some implementations, the storage device 3506 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 3502), perform one or more methods, such as those described above. The instructions can also be stored by one or more storage devices such as computer- or machine-readable mediums (for example, the memory 3504, the storage device 3506, or memory on the processor 3502).

The high-speed interface 3508 manages bandwidth-intensive operations for the computing device 3500, while the low-speed interface 3512 manages lower bandwidth-intensive operations. Such allocation of functions is an example only. In some implementations, the high-speed interface 3508 is coupled to the memory 3504, the display 3516 (e.g., through a graphics processor or accelerator), and to the high-speed expansion ports 3510, which may accept various expansion cards (not shown). In the implementation, the low-speed interface 3512 is coupled to the storage device 3506 and the low-speed expansion port 3514. The low-speed expansion port 3514, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 3500 may be implemented in a number of different forms, as shown in the figure. For example, it may be implemented as a standard server 3520, or multiple times in a group of such servers. In addition, it may be implemented in a personal computer such as a laptop computer 3522. It may also be implemented as part of a rack server system 3524. Alternatively, components from the computing device 3500 may be combined with other components in a mobile device (not shown), such as a mobile computing device 3550. Each of such devices may contain one or more of the computing device 3500 and the mobile computing device 3550, and an entire system may be made up of multiple computing devices communicating with each other.

The mobile computing device 3550 includes a processor 3552, a memory 3564, an input/output device such as a display 3554, a communication interface 3566, and a transceiver 3568, among other components. The mobile computing device 3550 may also be provided with a storage device, such as a micro-drive or other device, to provide additional storage. Each of the processor 3552, the memory 3564, the display 3554, the communication interface 3566, and the transceiver 3568, are interconnected using various buses, and several of the components may be mounted on a common motherboard or in other manners as appropriate.

The processor 3552 can execute instructions within the mobile computing device 3550, including instructions stored in the memory 3564. The processor 3552 may be implemented as a chipset of chips that include separate and multiple analog and digital processors. The processor 3552 may provide, for example, for coordination of the other components of the mobile computing device 3550, such as control of user interfaces, applications run by the mobile computing device 3550, and wireless communication by the mobile computing device 3550.

The processor 3552 may communicate with a user through a control interface 3558 and a display interface 3556 coupled to the display 3554. The display 3554 may be, for example, a TFT (Thin-Film-Transistor Liquid Crystal Display) display or an OLED (Organic Light Emitting Diode) display, or other appropriate display technology. The display interface 3556 may comprise appropriate circuitry for driving the display 3554 to present graphical and other information to a user. The control interface 3558 may receive commands from a user and convert them for submission to the processor 3552. In addition, an external interface 3562 may provide communication with the processor 3552, so as to enable near area communication of the mobile computing device 3550 with other devices. The external interface 3562 may provide, for example, for wired communication in some implementations, or for wireless communication in other implementations, and multiple interfaces may also be used.

The memory 3564 stores information within the mobile computing device 3550. The memory 3564 can be implemented as one or more of a computer-readable medium or media, a volatile memory unit or units, or a non-volatile memory unit or units. An expansion memory 3574 may also be provided and connected to the mobile computing device 3550 through an expansion interface 3572, which may include, for example, a SIMM (Single In Line Memory Module) card interface. The expansion memory 3574 may provide extra storage space for the mobile computing device 3550, or may also store applications or other information for the mobile computing device 3550. Specifically, the expansion memory 3574 may include instructions to carry out or supplement the processes described above, and may include secure information also. Thus, for example, the expansion memory 3574 may be provided as a security module for the mobile computing device 3550, and may be programmed with instructions that permit secure use of the mobile computing device 3550. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier and, when executed by one or more processing devices (for example, processor 3552), perform one or more methods, such as those described above. The instructions can also be stored by one or more storage devices, such as one or more computer- or machine-readable mediums (for example, the memory 3564, the expansion memory 3574, or memory on the processor 3552). In some implementations, the instructions can be received in a propagated signal, for example, over the transceiver 3568 or the external interface 3562.

The mobile computing device 3550 may communicate wirelessly through the communication interface 3566, which may include digital signal processing circuitry where necessary. The communication interface 3566 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 3568 using a radio-frequency. In addition, short-range communication may occur, such as using a Bluetooth®, Wi-Fi™, or other such transceiver (not shown). In addition, a GPS (Global Positioning System) receiver module 3570 may provide additional navigation- and location-related wireless data to the mobile computing device 3550, which may be used as appropriate by applications running on the mobile computing device 3550.

The mobile computing device 3550 may also communicate audibly using an audio codec 3560, which may receive spoken information from a user and convert it to usable digital information. The audio codec 3560 may likewise generate audible sound for a user, such as through a speaker, e.g., in a handset of the mobile computing device 3550. Such sound may include sound from voice telephone calls, may include recorded sound (e.g., voice messages, music files, etc.) and may also include sound generated by applications operating on the mobile computing device 3550.

The mobile computing device 3550 may be implemented in a number of different forms, as shown in the figure. For example, it may be implemented as a cellular telephone 3580. It may also be implemented as part of a smart-phone 3582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof.

These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

### Vendor Offboarding

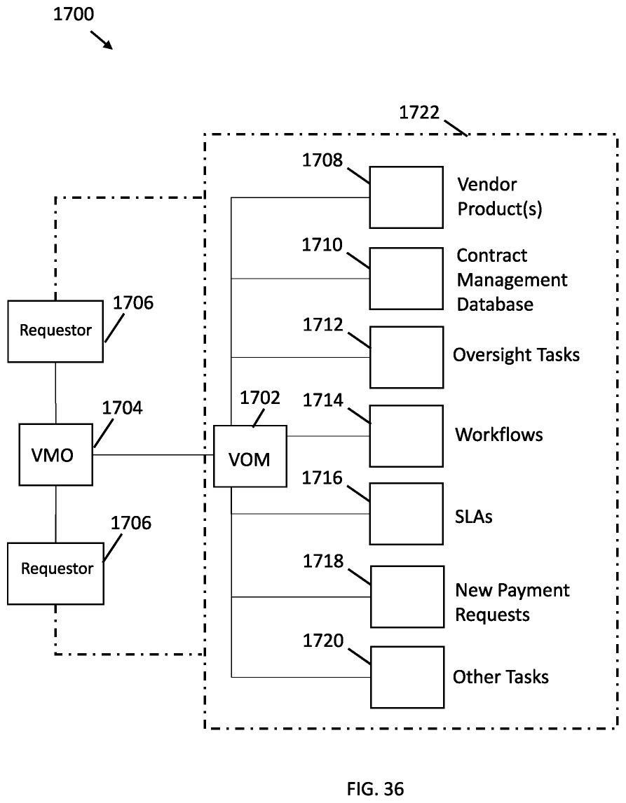

FIG. 36 illustrates a vendor offboarding system (and/or process flow) 1700 according to aspects of the present embodiments. The offboarding system 1700 may include enterprise software running on several managed devices or computers (such as laptops, desktops, mobile phones, tablets, and other devices) as well as on networks (for example, local area networks (LANs) and/or wide area networks (WANs) and/or servers). One or more requestors 1706 may request that a vendor be offboarded (for example, at the completion of a project, the vendor's works-cope or contract has come to a close, if the client has chosen a different vendor to work with instead and/or no longer needs the first vendor, as a result of a vendor dispute or underperformance, and/or for various other reasons). In some embodiments, the requestor 1706 may access and/or may be running a local version of the vendor offboarding module 1702 (for example, which is running on the requestor's laptop or desktop computer). In some embodiments, the requestor 1706 may access the vendor offboarding module 1702 directly from a server or web-enabled online platform, to which the requestor has been granted access. The process for drafting and submitting a vendor offboarding request is described in further detail below. Once the vendor offboarding request has been submitted by the requestor 1706, it is sent to the vendor management office or officer (VMO) 1704 (or administrator) who has the authority to grant or deny the offboarding request.

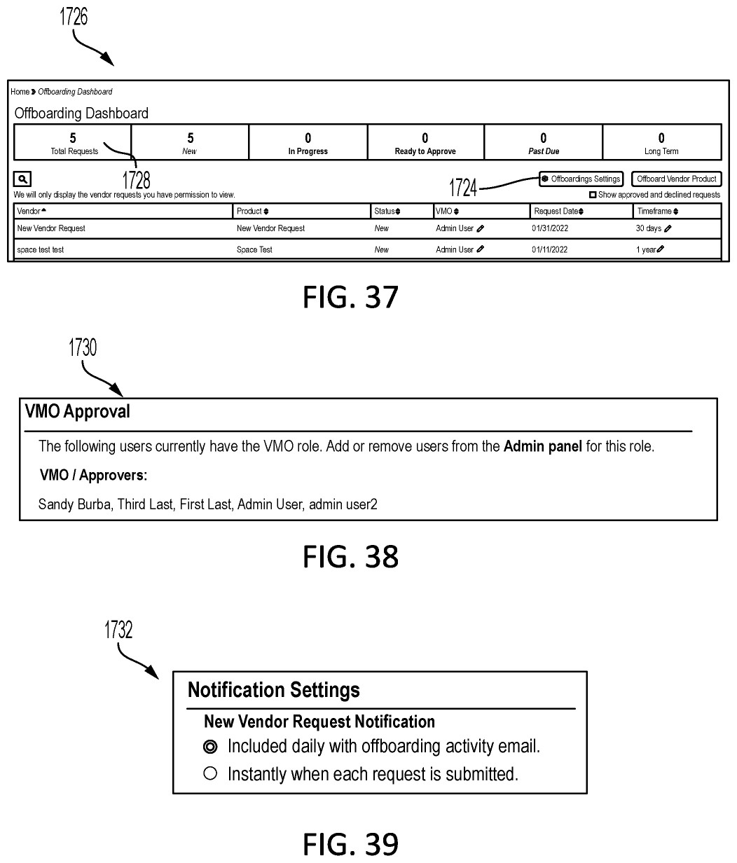

Referring still to FIG. 36, once a vendor offboarding request has been submitted by a requestor 1706, the vendor offboarding module (VOM) 1702 may send an acknowledgement back to the requestor 1706 indicating that the request has been received, and will then send a notification to the VMO 1704 indicating that an offboarding request has been received. The notification sent to the VMO 1704 may include a link (for example, a hyperlink) to the offboarding dashboard 1726 (shown in FIG. 37), where the vendor management officer (VMO) 1704 may view details relating to the vendor offboarding request (for example, reasons for the request, as well as other details). Once the VMO 1704 has reviewed the request in the VOM 1702, the VMO 1704 may approve or deny the request. In some embodiments, the VMO 1704 may also have the option to defer the request until a later date or indefinitely. If a vendor offboarding request is denied, the vendor offboarding system 1700 may send a notification back to the requestor 1706 notifying the requestor 1706 that the request has been denied. When a vendor offboarding request is denied, no changes are made to the status quo and the vendor products, data, contracts, authorizations, accesses levels are maintained (i.e., in an on-boarded state).

Still referring to FIG. 36, when a vendor offboarding request from a requestor 1706 is granted by the vendor management officer VMO 1704, several downstream actions may automatically be triggered from the vendor offboarding module 1702. In some embodiments, the vendor offboarding module 1702 may initiate the offboarding of one or more vendor products 1708 from the client networks, servers and/or managed devices. In some embodiments, the vendor offboarding module 1702 may send instructions to the contract management database or module 1710 to change the status of one or more contracts associated with the vendor in question from “active” to “terminated,” for example. In some embodiments, the vendor offboarding module 1702 may send a command or instructions to discontinue oversight tasks 1712 (such as, for example, report preparation in advance of financial regulatory reporting and/or examinations). In some embodiments, the vendor offboarding module 1702 may send a command or instructions to discontinue other workflows 1714 being performed by the vendor (or by vendor products and/or software). Commands and/or instructions to discontinue vendor workflows 1714 may include sending a notification (for example, via email and/or text message) to the vendor notifying the vendor that the workflow has been discontinued.

Referring still to FIG. 36, once a vendor offboarding request has been approved by the vendor management officer (VMO) 1704, the vendor offboarding module 1702 may also send a command or instructions to change the status of one or more service-level agreements (SLA) 1716 associated with the vendor, for example, from active to inactive. In some embodiments, the vendor offboarding module 1702 may send a command or instructions to temporarily suspend approvals on new payment requests 1718. In some embodiments, the vendor offboarding module 1702 may also terminate or suspend other tasks 1729 associated with the vendor. In each of the action types initiated by the vendor offboarding module 1702 (and stemming from a vendor offboarding request being granted) the action may be initiated immediately or alternatively, may be initiated at some future date selected by the client, for example, to allow certain vendor workflows to be completed, and/or to allow software from other vendors to fully install. In accordance with aspects of the present embodiments, the vendor offboarding module 1702 may direct software that is installed on managed devices, networks and servers to be uninstalled, once a vendor offboarding request has been approved. The downstream products, databases, workflows, and/or tasks 1708, 1710, 1712, 1714, 1716, 1718, 1720 may all be hosted within a client server and/or network 1722 (for example, a local area network (LAN) or a wide area network (WAN) that is accessible by the vendor management officer 1704 and requestor 1706. In some embodiments, local installations of the vendor offboarding module may be running on a user's (for example, a requestor 1706 or a vendor management officer 1704) laptop, desktop computer, mobile device, and/or other managed device that then may synchronize with the vendor offboarding module hosted on the server 1722.

FIG. 37 illustrates an example standard vendor offboarding form, according to aspects of the present embodiments. Administrators or users with the VMO 1704 role have access to the offboarding settings 1724 area of the vendor offboarding dashboard 1726. Turning the vendor offboarding functionality on or off dictates how a vendor is able to be offboarded. With vendor offboarding off, products are deactivated directly through the traditional method of cancelling contracts or inactivating vendors or products from the product profile. With vendor offboarding on, products must go through the offboarding request process using the Offboard Vendor Product button(s) in order to be deactivated, which then allows for the automatic cancellation of contracts and the deactivation of vendor products. The vendor offboarding dashboard 1726 displays the total number of offboarding requests 1728, as well as the new requests, in progress requests, requests that are ready to approve, requests that are past due, and long term requests. In some embodiments, only the requests that a user (for example, a requestor 1706 or VMO 1704) has permission to view will be displayed in the offboarding dashboard 1726.

FIG. 38 illustrates a view 1730 displayed by the vendor offboarding module 1702 indicating that in some embodiments, the vendor offboarding uses the same VMO 1704 role as the vendor onboarding module. Therefore, a user that has been designated as a VMO 1704 for onboarding will also be listed as a VMO 1704 for offboarding in the display 1730 of FIG. 38.

FIG. 39 illustrates a view 1732 displayed by the vendor offboarding module 1702 showing the notification settings. In some embodiments, new offboarding request notifications have the same frequency options as onboarding requests. Request emails can be set to send to VMO's instantly when each request is submitted or, batched and included daily with the daily offboarding activity email.

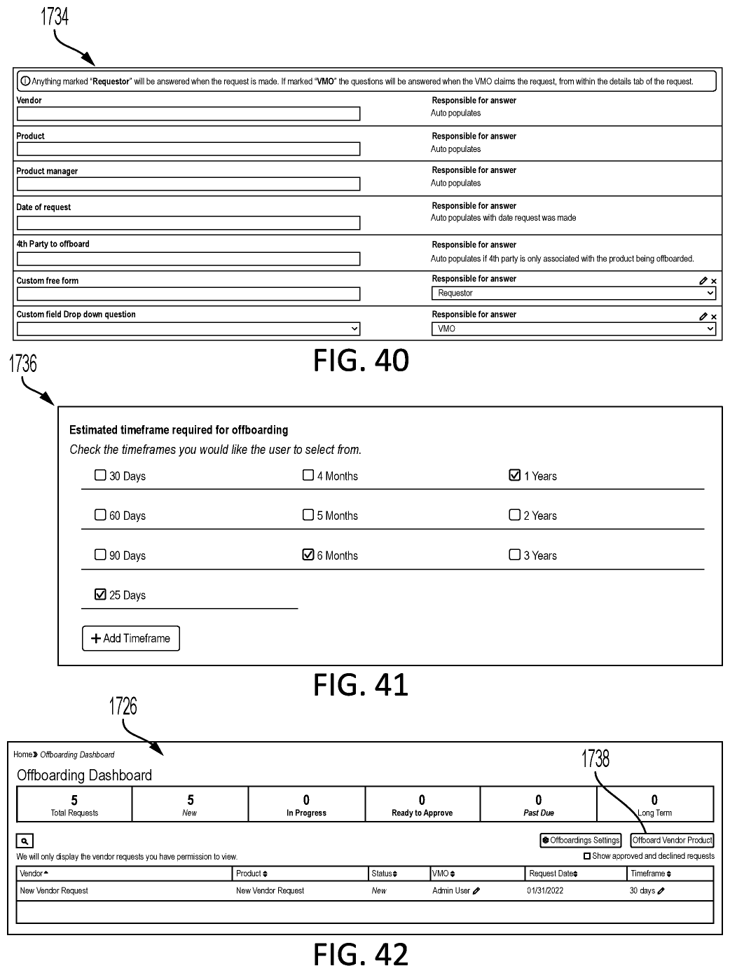

FIG. 40 illustrates a view of a vendor offboarding form 1734 as displayed by the vendor offboarding module 1702, according to aspects of the present embodiments. The vendor offboarding form 1734 may be or include a default vendor offboarding form including a number of pre-determined fields. In some embodiments, the vendor offboarding form 1734 may be or include a customized vendor offboarding form including fields selected by the client (for example, by an authorized user such as the VMO 1704). Once a form is edited and/or customized with the selected fields, it then becomes standardized and un-editable. Certain fields are required in order for the functionality of the vendor offboarding module 1702 to work properly, the require fields including the vendor, the product, the product manager, the date of request, the 4th party to offboard, the reason for offboarding, the estimated timeframe required for offboarding, the contract date, the termination effective date, and the last day for notification of intent not to renew. Each question on the vendor offboarding form 1734 has a designated user responsible for answering the question, the options for which include the VMO 1704 and the requestor 1706. In some embodiments, one or more questions can be auto populated based on information already known by the system. These questions will be indicated as such. Certain questions on the vendor offboarding form 1734 may be marked “requestor” meaning that the requestor must answer these questions when the request is made. Certain other questions may be marked as “VMO,” which indicates that these questions must be answered when the VMO opens and reviews the request, from within the details tab 1750 (shown in FIG. 44) of the request display.

FIG. 41 illustrates a view of the possible answers to the timeframe question 1736 of the vendor offboarding form 1734. The timeframe question 1736 is required for vendor offboarding and is permanently set to be answered by the requestor 1706, and will always be listed as the last question in the request details section of the vendor offboarding form 1734. Basic suggested timeframes (for example, daily up to several days, monthly up to a year, and/or yearly up to several years) are included in the timeframe question 1736, and clients can add a custom timeframe of their choosing. Adding one or more custom timeframes will add from left to right along the columns and will not add to columns based on day, month, or year. For the first phase of offboarding, timeframe options cannot be removed from the list. Multiple timeframes may be selected in the timeframe question 1736 such that the requestor's 1706 recommendations for timeframes and/or estimated ranges of timeframes can be viewed by the VMO 1704 and taken into consideration in finalizing the offboarding timeframe.

FIG. 42 illustrates a view of the vendor offboarding dashboard 1726, which includes an offboard vendor product button 1738 that is displayed when offboarding is turned on, both on the offboarding dashboard 1726, as well as in the product profile.

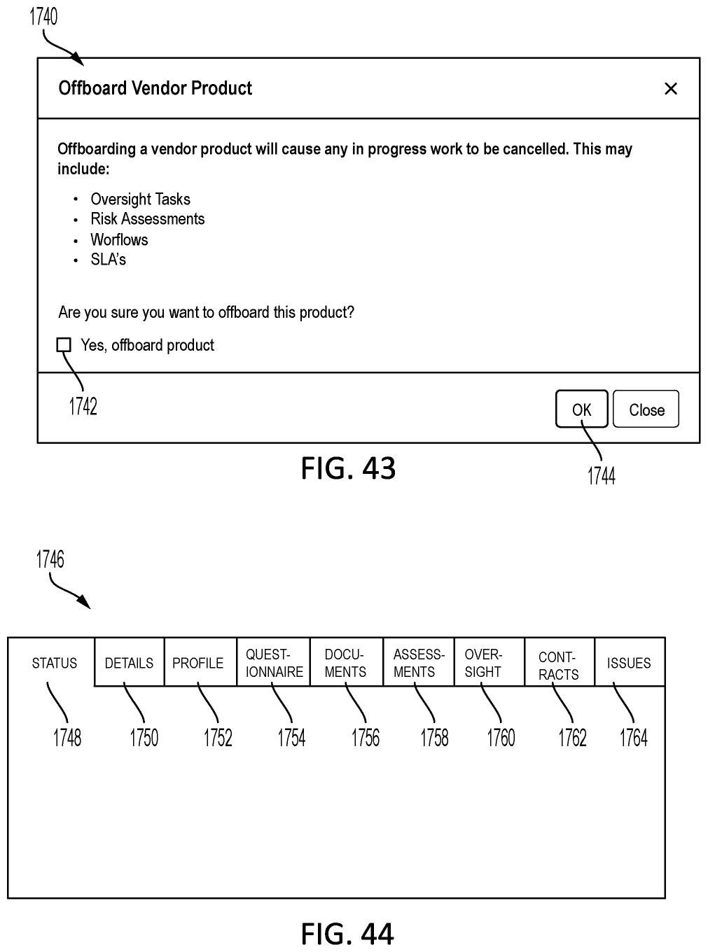

FIG. 43 illustrates an offboard vendor product dialog box 1740, according to aspects of the present embodiments. Only the product manager, administrators and VMOs 1704 can select to send a product to offboarding. Choosing to send a product to offboard will cancel all in-progress work like risk assessments and workflows. However, questionnaires and issues will remain open. The vendor product dialog box 1740 indicates that offboarding a vendor product will cause any progress work to be cancelled. The progress work may include one or more of oversight tasks, risk assessments, workflows, SLA's (service level agreements), vendor products, and/or other tasks. Because offboarding a vendor product halts the progression of progress work, the vendor product dialog box 1740 requires that a confirmation box 1742 be checked verifying that yes, the product should indeed be offboarded. The user (for example, a requestor, VMO 1704 or administrator must then click a submit or “okay” button 1744 in order to proceed with the vendor offboarding. After the confirmation box 1742 and the vendor product dialog box 1740 is submitted, the requestor 1706 will then be presented with the offboarding form 1734 that includes all questions where the answer owner was designated as requestor 1706. Upon submission of the offboarding form 1734, an offboarding request will be created and displayed on the offboarding dashboard 1726. New request notifications will be sent to VMOs 1704 based on the offboarding notification settings.

FIG. 44 illustrates a vendor request display 1746, according to aspects of the present embodiments. All offboarding requests submitted can be found on the offboarding dashboard 1726. However, the user's ability to see and edit the offboarding request depends on their involvement. Permissions will follow onboarding guidelines. Stated otherwise, a user's permission or access levels for onboarding will automatically carryover to the user's offboarding permission levels. A user with the administrator and/or VMO 1704 role will see all vendor requests on the vendor request display 1746. A user that is not an administrator nor VMO 1704 will only see vendor requests (on the vendor request display 1746) that they submitted or vendor requests for which they are assigned to complete a section or workflow step on.

Referring still to FIG. 44, vendor offboarding edit rights are similar to view rights. An administrator or VMO 1704 can edit any part of a vendor request so long as they are not the requestor 1706; requestor 1706 role trumps administrator/VMO 1704 role. For example, if a user who is a VMO 1704 initiates a request (making that user the requestor 1706), that user cannot also assume the VMO 1704 role for that particular request. Another user will have to act as VMO 1704 role for that particular request to ensure proper oversight protocols are maintained for vendor offboarding. A requestor 1706 can edit only the section for which they are assigned; assignment trumps requestor role. In other words, if a user who is a requestor 1706 is also assigned a section to edit, their role as assignee carries precedence over their role as requestor 1706, in the event of conflicts between the two roles. Any user that can see the request can add a note on the status tab 1748. Any user that can see the request can upload a document on the documents tab 1756.

Still referring to FIG. 44, the vendor request display 1746 includes 9 tabs: a status tab 1748, a details tab 1750, a profile tab 1752, a questionnaire tab 1754, a documents tab 1756, an assessments tab 1758, an oversight tab 1760, a contracts tab 1762, and an issues tab 1764. The status tab 1748 provides an overview area for vendor information, VMO information, a notes area, and links (for example, hyperlinks) to workflows. The details tab 1750 displays the vendor offboarding request form 1734 and contains two tabs for vendor/product and request details. These tabs contain the form questions for their respective sections of the form. The details tab 1750 is also where VMOs 1704 will complete any questions from these sections where they were designated as being responsible for the answer. If there are unanswered questions on one tab, that tab will be the default landing. If both tabs have unanswered questions, or all questions are answered, then the default landing is on the vendor/product tab. The profile tab 1752 contains the vendor and product profiles. Changes to the vendor profile here will apply in “ongoing” state if there is still an active ongoing product for the vendor. If the offboarding request is declined and returned to “ongoing” status, any changes to the product profile will be updated to reflect “ongoing” status. The questionnaire tab 1754 is similar to the corresponding section from the ongoing vendor dashboard. The questionnaire tab 1754 also displays a questionnaire history, as well as a button (or selectable option) for sending additional questionnaires.

Referring still to FIG. 44, the documents tab 1756 is similar to the corresponding section from the ongoing vendor dashboard. Previously loaded documents for this product can be found in the documents tab 1756. New documents can also be uploaded via the documents tab 1756. The assessments tab 1758 is similar to the corresponding section from the ongoing vendor dashboard. The assessments tab 1758 also displays an assessment history, and provides the option (for example, via a button) to perform additional assessments. The oversight tab 1760 is similar to the corresponding section from the ongoing vendor dashboard. The oversight tab 1760 also displays an oversight history, and provides the option (for example, via a button) to perform additional oversight requirements, if needed. The contracts tab 1762 lists all contracts for the product with links to the full contract details page. The contracts tab 1762 is where all questions from the contracts section of the request form are displayed. VMOs 1704 may answer all contract section form questions in the contracts tab 1762. Form questions are per contract and the contracts tab 1762 provides the option to allow each form question to be answered for each contract listed. The issues tab 1764 is similar to the corresponding section from the ongoing vendor dashboard. The issues tab 1764 also displays an issues history, and provides the option (for example, via a button) to create new issues, if needed. Within an offboarding request, a VMO 1704 can assign a user to complete sections or mark the section as not required. Assignable sections include the details tab 1750, the questionnaire tab 1754, the assessments tab 1758, the oversights tab 1760, and/or the contracts tab 1762.

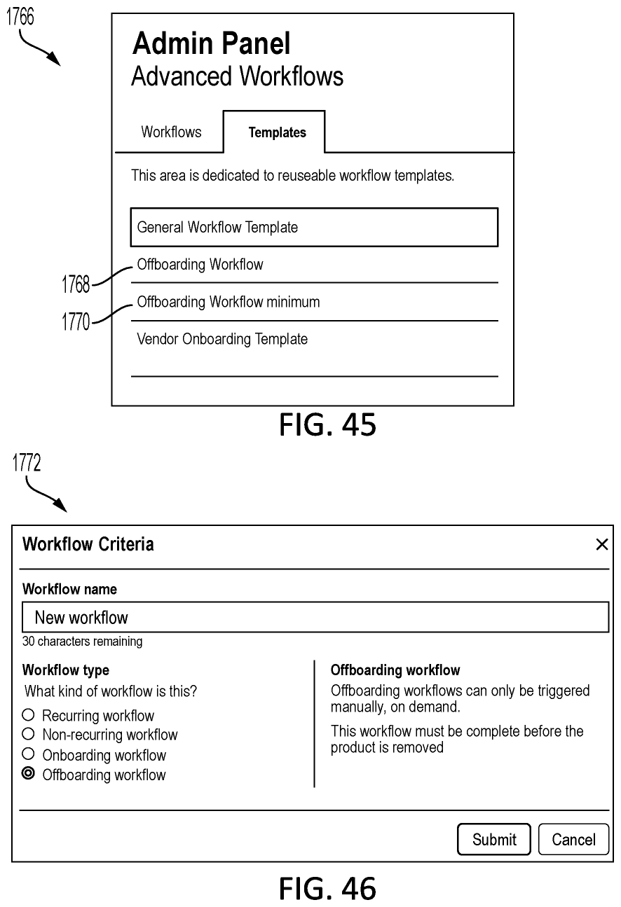

FIG. 45 illustrates an administrative panel 1766 including offboarding workflow templates, according to aspects of the present embodiments. Workflows are an effective way to optimize offboarding so that an individual ‘checklist’ of activities can be created and signed off on throughout vendor offboarding. Clients with both offboarding and workflows will see two new offboarding workflow templates in the admin panel: offboarding workflow 1768, and offboarding workflow minimum 1770. The offboarding workflow minimum template 1770 is a scaled back version of the full offboarding workflow template 1768.

FIG. 46 illustrates a new offboarding workflow form 1772, according to aspects of the present embodiments. When adding a new custom workflow via the new offboarding workflow form 1772, there is an option to designate the workflow as an “offboarding workflow.” All offboarding workflows can only be triggered manually (on demand), and any in flight workflows must be completed before an offboarding request can be approved. In some embodiments, there can be more than one active Offboarding Workflow template, and Offboarding requests can have more than one in flight Offboarding workflow.

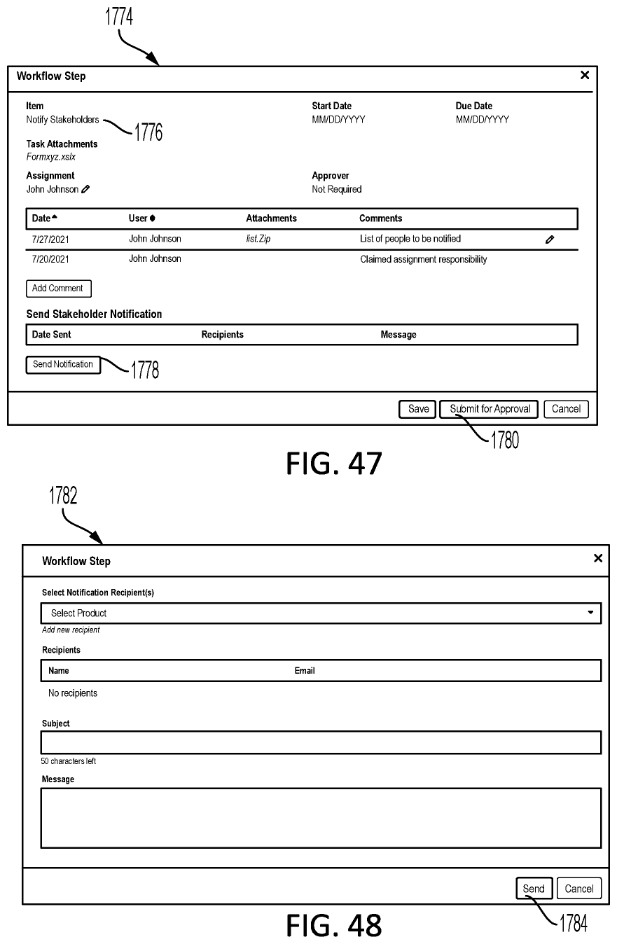

FIG. 47 illustrates a preloaded offboarding workflow 1774, according to aspects of the present embodiments. The preloaded offboarding workflow 1774 (full version) includes a step 1776 titled “Notify Stakeholders.” This step introduces new functionality to workflows, allowing the user to send a custom notification (i.e., via button 1778) directly from the “Notify Stakeholders” Workflow step. For example, when the user presses the send notification button 1778, the preloaded offboarding workflow 1774 causes the processor to send an email to the relevant stakeholders including the requestor 1706, any assignees (i.e., those who have been assigned a section of the underlying offboarding request to be completed), the vendor, any 4th parties, the VWO 1704 or administrator, and any other stakeholders including non-user vendor personnel. The email notifies the stakeholders of the impending vendor offboarding request, such that any of the stakeholders can take immediate action, as necessary, to delay or pause the vendor offboarding request, should the stakeholder(s) believe that the vendor offboarding request has been made in error, or should the stakeholder(s) believe not all relevant information has been taken into consideration prior to the vendor offboarding request being made, as well as for other reasons. In some embodiments, when the submit for approval button 1780 is clicked, the preloaded offboarding workflow 1774 automatically causes the processor to send an automated notification of the offboarding request submittal to the stakeholders (for example, via text message, email message, automated phone call, and other suitable messaging means). Within the edit view of the stakeholder step, the user may select “Send Notification”, then choose the applicable “stakeholders” as recipients. The recipient dropdown list will include all active and enrolled users and includes a multi select (i.e., the option to select multiple recipients). In some embodiments, non-users may be added as recipients (for example, vendor executives and vendor administrators who are not users of the system). After the recipient(s) is/are selected, the user can enter a custom subject line and message form 1782 (as shown in FIG. 48) that will be automatically sent from the platform to the selected recipient(s) upon selection of the “send” button 1784. In some embodiments, the user can select a default message (i.e., rather than providing a custom message) indicating that the vendor offboarding request has been submitted for approval and including certain default information about the request (for example, the reason for the offboarding request, and/or the estimated timeframe for completing the request, among other possible information or request details).

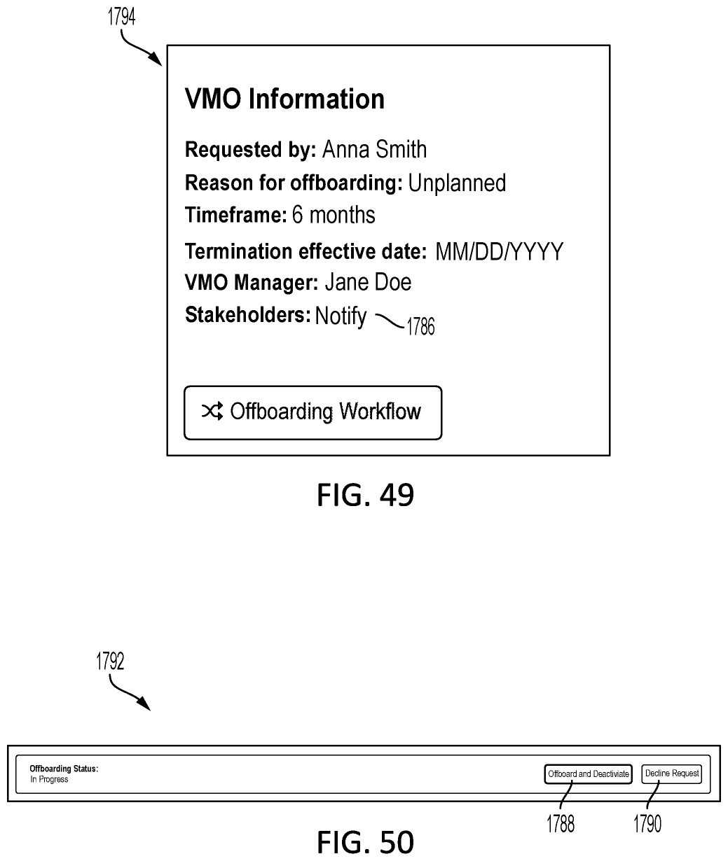

Referring to FIG. 48, which illustrates a custom message form 1782, once a stakeholder notification has been sent, the date, recipients, and message will be listed inside of the workflow step for reference. Recipients will be listed as “Stakeholders” in the VMO Information section 1794 of the status tab 1748. If no stakeholders have been notified, there will be a “notify” link that opens to the workflow step, i.e., when the word “Notify” 1786 is clicked, as shown in FIG. 49.

FIG. 50 illustrates a final approve/decline action bar 1792, according to aspects of the present embodiments. The final approve/decline action bar 1792 includes an offboard and deactivate button 1788, as well as a decline request button 1790. In some embodiments, the offboard and deactivate button 1788 may appear in red (as opposed to gray or white for the decline request button 1790), to convey the importance of clicking (or not clicking) the offboard and deactivate button 1788 one final time before the request is approved, for example. Declining an offboarding request will mark the request as declined and send the product back to an active ongoing status. Declining an offboarding request will also cause the vendor offboarding module 1700 to retain all offboarding information (forms, notes, workflow history, etc.) in the offboarding request. Selecting “Decline Request” opens a modal for the VMO 1704 where the VMO 1704 can enter a comment that will be sent to the requestor 1706. The VWO 1704 can also retain the current contract(s) that are on file or replace the contract(s) with one or more new ones.

Referring still to FIG. 50, approving an offboarding request (via the offboard and deactivate button 1788) will mark the request as approved, and will inactivate the product. Approving the offboarding request will also cause the vendor offboarding module 1700 to retain all offboarding information (forms, notes, workflow history, etc.) in the offboarding request. Selecting “Offboard and Deactivate” (via the offboard and deactivate button 1788) will open a modal for the VMO 1704 allowing the VMO 1704 to enter a comment that will be sent to the requestor 1706. In some embodiments, when the offboard and deactivate button 1788 is clicked by the vendor management officer 1704 thereby approving the vendor offboarding request, the vendor offboarding module 1700 causes the processor to terminate access of the vendor product by deleting permissions associated with the vendor product from all managed devices.

In some embodiments, when the offboard and deactivate button 1788 is clicked by the vendor management officer 1704 thereby approving the vendor offboarding request, the vendor offboarding module 1700 causes the processor to send an executable file to a network scheduler for deployment to all managed device at a time and/or date within the estimated timeframe 1736 for offboarding. In some embodiments, the executable file uninstalls the vendor product from all managed devices and/or from networks and servers within the LAN or WAN. In some embodiments, the executable file includes an address indicating where the vendor product of software is installed on each of the managed devices. In some embodiments, the address indicating where the vendor product of software is installed on each of the managed devices is imported from a configuration file that is created during the onboarding process. In some embodiments, the executable file uses the address to uninstall the product or software from the managed devices. For example, in some embodiments, when the offboard and deactivate button 1788 is clicked the vendor offboarding module 1700 causes the processor to create an executable file, send the executable file to a network scheduler with instructions to deploy the executable file to all managed devices on a predetermined date within the offboarding timeframe 1736 and run the executable file on each of the managed devices to uninstall the vendor product or software, the executable file including the local address where the vendor software is installed on each managed device. In some embodiments, when the offboard and deactivate button 1788 is clicked by the vendor management officer 1704 thereby approving the vendor offboarding request, the vendor offboarding module 1700 causes the processor to send instructions to the network to distribute a second executable file to each managed device, the second executable file programmed to identify the locations of each configuration file, data file, and/or other ancillary files needed to run the vendor product or software, and to subsequently purge (or delete) each configuration file, data file, and other ancillary file(s) from the local storage of each managed device.

In some embodiments, when the offboard and deactivate button 1788 is clicked by the vendor management officer 1704 thereby approving the vendor offboarding request, the vendor offboarding module 1700 causes the processor to change a status of one or more contracts in the contract management database 1710 from active to inactive. In some embodiments, when the offboard and deactivate button 1788 is clicked by the vendor management officer 1704 thereby approving the vendor offboarding request, the vendor offboarding module 1700 causes the processor to send a notification to the stakeholders that the status of one or more contracts in the contract management database 1710 has changed from active to inactive. In some embodiments, when the offboard and deactivate button 1788 is clicked by the vendor management officer 1704 thereby approving the vendor offboarding request, the vendor offboarding module 1700 causes the processor to temporarily or permanently freeze the processing of one or more new (or existing) payment requests 1718 from the vendor. In some embodiments, when the offboard and deactivate button 1788 is clicked by the vendor management officer 1704 thereby approving the vendor offboarding request, the vendor offboarding module 1700 causes the processor to halt one or more oversight tasks 1712, one or more workflows 1718, and/or one or more other tasks 1720. In some embodiments, when the offboard and deactivate button 1788 is clicked by the vendor management officer 1704 thereby approving the vendor offboarding request, the vendor offboarding module 1700 causes the processor to change the status of one or more service level agreements 1716 from active to inactive. In some embodiments, when the offboard and deactivate button 1788 is clicked by the vendor management officer 1704 thereby approving the vendor offboarding request, the vendor offboarding module 1700 causes the processor to send a notification to the stakeholders that the status of one or more service level agreements 1716 has changed from active to inactive. In some embodiments, when the offboard and deactivate button 1788 is clicked by the vendor management officer 1704 thereby approving the vendor offboarding request, the vendor offboarding module 1700 causes the processor to send instructions to the network or server to deactivate each individual user's access to the vendor product or software running on the network or server.

In some embodiments, the approval that was required during vendor onboarding, may dictate what level of approval is required for vendor offboarding. For example, in some embodiments, if a vendor did not require approval for onboarding, the vendor will not require approval for offboarding. In some embodiments, if a vendor did require approval for onboarding, the vendor will require approval for offboarding, unless the person requesting the vendor to be off-boarded was the original approver (for example, a VMO) in which case, the request for offboarding is considered to be self-approved, and no further approval is required for the vendor offboarding request. In some embodiments, where multiple VMOs are assigned to and/or associated with a single vendor for whom an offboarding request has been made, approval is required from all of the multiple VMOs. Accordingly, in some embodiments, a higher number of approvals are required to offboard a vendor than to onboard a vendor (which may include the approval of only a single VMO). In some embodiments, the present system and methods include an offboarding period, during which time an offboarding request may be approved and finalized before the vendor to be offboarded is purged from the system. For example, in some embodiments, an offboarding period may include a timeframe of about 7 days, 14 days, 21 days, 30 days, 45 days, 60 days, 90 days, 180 days, 1 year, etc. In some embodiments, the offboarding period is initiated as soon as an offboarding request is submitted. In some embodiments, the offboarding period is initiated once an offboarding request has been approved. In some embodiments, the offboarding period is defaulted to 30 days, 60 days, and/or 90 days. In some embodiments, a VMO may choose an amount of time to use as a default period. In some embodiments, during the offboarding period, all actions and functionality associated with a vendor is grayed out such that no actions associated with that vendor may able to be taken by any users. For example, in some embodiments, when a user hovers the mouse over a grayed out field, a text (for example, in a pop-up bubble) is displayed indicating that the vendor is in the process of being off-boarded. In some embodiments, the user who made the original vendor offboarding request may withdraw the offboarding request during the offboarding period, thereby restoring the status of the vendor in question back to “on-boarded.”

The present embodiments include systems and methods that address the problem of how to ensure that a vendor is not offboarded prematurely, especially since there are multiple factors to consider. Accordingly, the present embodiments may include computing systems (for example, enterprising systems, laptops, desktops and other PCs, mobile devices, and other suitable devices as described herein) configured and/or programmed to carry out the functionality described herein. For example, in some embodiments, the disclosed systems include computer register or memory locations and/or modules (i.e., including routines) for flagging that certain factors have been checked before a vendor is fully purged from the system. A first flag may including checking what level or type of approval (i.e., an approval type flag) was required for the vendor to be on-boarded. If approval was not required for onboarding, then in some embodiments, approval is not required for offboarding. In such situations, the only additional flags that would need to be checked is whether or not the offboarding period has elapsed, and whether the original offboarding request has been withdrawn. If the offboarding period (i.e., the offboarding period flag) has not elapsed, than the vendor will appear as grayed out, but will not have been purged from the system yet. In situations in which approval was required for onboarding, the system will check to see if the offboarding request has been approved (unless the offboarding request was made by the same approver or VMO who approved the onboarding request, in which case no further approval is required for the offboarding request). If approval one or more approvals are required for the offboarding request (i.e., a request approval flag), the system checks to see if more than one VMO is associated with the vendor, and if so, if all of the associated VMOs have approved the offboarding request. Finally, the system checks to see if the vendor offboarding request has been withdrawn (i.e., the request withdrawal flag). Accordingly, for a vendor to be fully purged from the system, the system checks to verify 1) what level of approval is needed for the request, based on the onboarding approval, 2) if all of the required offboarding approvals have been received, 3) whether or not the offboarding period has elapsed, and 4) whether or not the offboarding request has been withdrawn by the original requestor. Only after all of the flags have been confirmed will the system purge the vendor from the system, as described according to the present embodiments. In some embodiments, the system is programmed to run the offboarding routine for all offboarding requests (i.e., checking that all of the flags have been confirmed) on a daily basis, and only once per day, thereby alleviated clients from having to continuous monitor and track the status of various flags during the offboarding process. Accordingly, as soon as a vendor offboarding request is made, the system automatically identifies what approvals are needed for the offboarding to be finalized, and tracks the associated the flags. As soon as all of the flags are met, the vendor is automatically purged from the system (for example, within a period of about 24 hours once the system has had a chance to run the daily offboarding request). In some embodiments, a request may be made by a system user (to be reviewed and approved by a VMO and/or the original offboarding requestor) to extend the offboarding period for an additional period of time (for example, 1 or 2 days, 1 week, 2 weeks, 3 weeks, a month etc.). Accordingly, a flag indicating that the offboarding period has expired may take longer to satisfy if the offboarding period has been extended.

In some embodiments, the offboarding period allows vendors to rectified issues, thereby enabling the original offboarding requestor and/or one or more VMOs to either withdraw the request, and/or deny the offboarding request (for example, if the circumstances leading to the original offboarding request have been rectified and/or mitigated). In some embodiments, the system maintains a separate register (i.e., system memory accessible to users of the system) allocated to tracking which vendors are associated with which routines and subroutines of the enterprise system). For example, in some embodiments, as soon as a vendor offboarding request is made and/or approved (depending on what the desired trigger is) the system may execute programming that causes one or more processors to consult the separate register to identify which fields the system should gray out, thereby disabling the underlying functionality associated with the vendor in question. In some embodiments, if a vendor offboarding request has been denied and/or withdrawn, the system will automatically un-gray the previously grayed-out fields, thereby allowing those fields (and associated functionality) to be useable again.

### Email Notifications

The system 100 may take actions and set reminders. Example actions of the system 100 are summarized in Table 7, and may include email notifications. In some embodiments, the vendor offboarding module 1702 creates notifications when certain activities occur to alert responsible individuals. Several example email notifications and their triggers are shown in Table 7.

TABLE 7

| Email Template | Description | Trigger |
|---|---|---|
| Vendor Offboarding | Sent to client's active and enrolled | Client turns Vendor |
| Activated | users with the VMO role to inform | Offboarding On |
| | them that vendor offboarding has | (Settings in Vendor |
| | been turned on. | Offboarding module) |
| Vendor Offboarding | Sent to client's active and enrolled | Client turns Vendor |
| Deactivated | users with the VMO role to inform | Offboarding Off |
| | them that vendor offboarding has | (Settings in Vendor |
| | been turned off. | Offboarding module) |
| Offboarding Request | Sent to the user who is the requestor | Offboarding Request |
| Approved | and cc's user who approved the | Approved |
| | vendor request. | |
| Offboarding Request | Sent to the user who is the requestor | Offboarding Request |
| Declined | to inform them that the offboarding | Declined |
| | request was declined. | |
| Vendor Request Section | Sent to user assigned to complete a | Requirement/Section |
| Assignment | section within a vendor request to | assignment and every 3 |
| | remind them they have work to do. | business days until section is |
| | | marked as complete or not |
| | | required. |
| New Offboarding | Sent to active and enrolled users with | Based on Offboarding |
| Requests | the VMO role to inform them that | settings. Either instantly or |
| | there are New vendor requests. | daily in the Today's |
| | | Offboarding Activity email. |
| Vendor Offboarding | Sent to user who is assigned as the | Request status changed from |
| Request Received | offboarding request requestor. | new to in progress. |
| | | (Request is claimed by |
| | | VMO) |
| Today's Offboarding | Sent to VMO's and users with | There are vendor |
| Activity | assignments | requests in new |
| | | status. |
| | | Request is assigned |
| | | to VMO (not sent if |
| | | VMO claims) |
| | | Section is assigned to |
| | | user |
| | | Section has a status |
| | | of completed |
| Offboarding Stakeholder | Sent to active & enrolled users | When ‘send’ is selected in |
| Notification | identified in the Workflow Notify | the workflow step |
| | Stakeholder step | |

### EQUIVALENTS

It is to be understood that while the disclosure has been described in conjunction with the detailed description thereof, the foregoing description is intended to illustrate and not limit the scope of the invention(s). Other aspects, advantages, and modifications are within the scope of the claims.

This written description uses examples to disclose the invention, including the best mode, and also to enable any person skilled in the art to practice the present embodiments, including making and using any devices or systems and performing any incorporated methods. The patentable scope of the present embodiments is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for managing one or more vendors and/or products, the method comprising the steps of:
causing to display, by a processor of an enterprise system, one or more graphical user interfaces (GUIs) associated with one or more vendor request modules, the one or more vendor request modules comprising a vendor offboarding module;
receiving, by the processor of the enterprise system, a first input from a first client user, the first input comprising instructions to access a vendor request form, the first client user comprising a vendor offboarding requestor, the vendor request form comprising a vendor offboarding request form;
receiving, by the processor of the enterprise system, data field information related to said vendor and/or product; and
updating, in a memory of the enterprise system, vendor and/or product information stored in association with the first client, based on the subsequent input.

2. The method of claim 1, further comprises sending the vendor offboarding request form to a vendor management officer (VMO) for approval, wherein the vendor offboarding request form comprises a vendor offboarding request.

3. The method of claim 2, wherein upon approving, by the vendor management officer (VMO), the vendor offboarding request, the processor causes a status of at least one contract in a contract management system to change from active to inactive.

4. The method of claim 2, wherein upon approving, by the vendor management officer (VMO), the vendor offboarding request, the processor causes a status of at least one service level agreement to change from active to inactive.

5. The method of claim 2, wherein upon approving, by the vendor management officer (VMO), the vendor offboarding request, the processor causes at least one vendor product to be deactivated.

6. The method of claim 5, wherein approving the vendor offboarding request comprises clicking an offboard and deactivate button.

7. The method of claim 6, further comprising:
after approving the vendor offboarding request, sending an executable file to a network scheduler for deployment to all managed device that are running the vendor product.

8. The method of claim 7, wherein the executable file uninstalls the vendor product from all managed devices.

9. The method of claim 7, wherein the executable file uninstalls the vendor product from all networks and servers operating within at least one of a local area network (LAN) and a wide area network (WAN) in which the vendor product is operating.

10. The method of claim 8, wherein the executable file comprises an address indicating where the vendor product is installed on each of the managed devices.

11. The method of claim 10, wherein the address is imported from a configuration file that is created during an onboarding process during which the vendor product was installed on each of the managed devices.

12. The method of claim 10, wherein the executable file uses the address to uninstall the product from the managed devices.

13. The method of claim 1, wherein the subsequent input is or comprises data field information requesting approval of a vendor offboarding request.

14. A method for managing one or more vendors and/or products, the method comprising the steps of:
causing to display, by a processor of an enterprise system, one or more graphical user interfaces (GUIs) associated with one or more vendor request modules;
receiving, by the processor of the enterprise system, a first input from a first client user, the first input comprising instructions to access a vendor request form;
receiving, by the processor of the enterprise system, data field information related to said vendor and/or product,
updating, in a memory of the enterprise system, vendor and/or product information stored in association with the first client, based on the subsequent input;
wherein the vendor request module is configured to track one or more vendor and/or product metrics associated with the vendor.

15. A method for offboarding one or more vendors, the method comprising the steps of:
executing an offboarding routine comprising checking that a series of flags are satisfied; and
automatically purging the vendor from the system once every flag of the series of flags are satisfied,
wherein the series of flags comprise one or more of an approval type flag, a request approval flag, a offboarding period flag, and a request withdrawal flag.

16. The method of claim 15, further comprising automatically disabling system functionality associated with the one or more vendors upon at least one of the following conditions occurring:
a vendor offboarding request is made; and
a vendor offboarding request is approved.

17. A system configured to carry out the method of claim 15.
